(19) United States
(12) Patent Application Publication
(10) Pub. No.: US 2010/0141395 A1
(43) Pub. Date: Jun. 10, 2010

(54) APPARATUS FOR COMMUNICATING WITH RFID TAG

(75) Inventor: Takuya NAGAI, Aichi-ken (JP)

Correspondence Address: DAY PITNEY LLP, 7 TIMES SQUARE, NEW YORK, NY, 10036-7311, US

(73) Assignee: Brother Kogyo Kabushiki Kaisha, Aichi-ken (JP)

(21) Appl. No.: 12/692,034

(22) Filed: Jan. 22, 2010

Related U.S. Application Data
(63) Continuation-in-part of application No. PCT/JP2008/066312, filed on Sep. 10, 2008.

(30) Foreign Application Priority Data
Sep. 25, 2007 (JP) 2007-246505

(51) Int. Cl. H04Q 5/22

(52) U.S. Cl. 340/10.4

(57) ABSTRACT

The disclosure discloses an apparatus for communicating with an RFID tag, comprising; a radio communication device; a tag number estimation portion configured to estimate the number of RFID tag circuit elements in a peripheral area of said apparatus; a storage device configured to store a list of identification information of each of a plurality of said RFID tag circuit elements; and a mode switching portion configured to switch a mode into a plural tag detection mode in which identification information is sequentially specified in said list stored in said storage device before the RFID tag circuit element corresponding to the specified identification information is detected through said radio communication device, or a response determination mode in which identification information is obtained from each of all the RFID tag circuit elements in said peripheral area through said radio communication device before presence of each of the RFID tag circuit elements respectively corresponding to the identification information in said list is determined on the basis of the obtained identification information, according to an estimation result by said tag number estimation portion.

### CROSS-REFERENCE TO RELATED APPLICATION

This is a CIP application PCT/JP2008/66312, filed Sep. 10, 2008, which was not published under PCT article 21(2) in English.

### BACKGROUND OF THE INVENTION

1. Field of the Invention

The present invention relates to an apparatus for communicating with a radio frequency identification (RFID) tag configured to conduct information transmission and reception via radio communication with an RFID tag capable of communication with the outside.

2. Description of the Related Art

In the case of article management, an RFID tag is disposed on an article to be managed, and an apparatus for communicating with an RFID tag that reads information held by the RFID tag in a non-contact manner is already known. A system using the apparatus for communicating with an RFID tag is referred to as a Radio Frequency Identification (hereinafter referred to as RFID) system.

In the RFID system, an RFID tag circuit element disposed in a label-shaped RFID tag, for example, is provided with an IC circuit part and a tag antenna. The IC circuit part stores predetermined RFID tag information. The tag antenna is connected to the IC circuit part and conducts information transmission and reception. Even if the RFID tag is stained or arranged at a hidden position, reading and writing of information with respect to the IC circuit part is capable with an apparatus antenna of the apparatus for communicating with an RFID tag. The RFID system has been already put into practice in various fields.

In article management using such an RFID system, a prior art reference relating to position detection of an article has been already proposed. In this prior art reference, an RFID tag circuit element for book is disposed on each of books to become position detection targets. Also, an RFID tag circuit element for shelf for giving position information is disposed on each shelf of a bookcase. A handheld reading device operated by an administrator of the books reads first tag identification information of the RFID tag circuit element for book disposed on each book in the bookcase sequentially from one side to the other side of the shelf. After that, when the reading reaches the end of the shelf, the reading device reads second tag identification information of the RFID tag circuit element for shelf. Then, these two types of tag identification information are both transmitted from the reading device to an operation terminal via radio communication. After that, the operation terminal associates the first tag identification information with the second tag identification information transmitted from the reading device as above through an appropriate operation by the administrator. As a result, book information such as names and contents of the books are associated with position information, that is, shelf information of the book and stored in a database.

In the above prior art reference, if an operator wants to know a storage position of a book, the following operation is needed. That is, by means of an operation of the operator, a terminal for operation accesses the database using the name of the book, for example, as a key. As a result, the first tag identification information of the RFID tag circuit element for book and the second tag identification information of the RFID tag circuit element for shelf corresponding to the first tag identification information are obtained. After that, by means of an appropriate operation by the operator, the terminal for operation transmits both the two pieces of the tag identification information to a handheld reading device via radio communication. The handheld reading device displays a location of the corresponding bookcase by a display device on the basis of the transferred second tag identification information. By means of this display, the handheld reading device guides the operator to a front of the bookcase. By means of the operation by the guided operator, the handheld reading device reads the second tag identification information from the RFID tag circuit element for shelf of the bookcase. As a result, the operator confirms that the bookcase is a correct intended one. After that, the operator specifies the first tag identification information corresponding to the book to be searched using the handheld reading device. The handheld reading device makes a search for each shelf of the bookcase on the basis of the specified first tag identification information. If the RFID tag circuit element for book provided with the first tag identification information is found, the handheld reading device makes corresponding position display. As a result, the location of the book to be searched can be notified to the operator.

As described above, the prior art reference requires many procedures such as input of the name of the book, for example, in the terminal for operation by the operator, transfer of the tag identification information from the terminal for operation to the handheld reading device, movement of the operator according to the bookcase display, confirmation by the operator of the reading of the second tag identification information, and search for each shelf of the bookcase by the handheld reading device using the first tag identification information. As a result, the operator needs extremely cumbersome many operations. In order to avoid this, there can be a method of directly searching the RFID tag circuit element for book without using the RFID tag circuit element for shelf. However, in this case, the handheld reading device performs reading one by one for each of the RFID tag circuit elements for book of the large number of books arranged on a plurality of shelves in a plurality of bookcases. In this case, it takes very long time to search for the targeted RFID tag circuit element for book, which was poor in efficiency.

### SUMMARY OF THE INVENTION

The present invention has an object to provide an apparatus for communicating with an RFID tag that can efficiently search a targeted RFID tag circuit elements.

The present invention is an apparatus for communicating with an RFID tag, comprising; a radio communication device configured to conduct radio communication with a plurality of RFID tag circuit elements, each of the RFID tag circuit elements having an IC circuit part storing information and a tag antenna capable of transmission and reception of the information; a tag number estimation portion configured to estimate the number of the RFID tag circuit elements in a peripheral area of the apparatus; a storage device configured to store a list of identification information of each of a plurality of the RFID tag circuit elements as search targets; and a mode switching portion configured to switch a mode into a plural tag detection mode or a response determination mode on the basis of a estimation result by the tag number estimation portion, the plural tag detection mode being a mode in which identification information is sequentially specified in the list stored in the storage device before the RFID tag circuit element corresponding to the specified identification information is detected through the radio communication device, the response determination mode being a mode in which identification information is obtained from each of all the RFID tag circuit elements in the peripheral area through the radio communication device before presence of each of the RFID tag circuit elements respectively corresponding to the identification information in the list is determined on the basis of the obtained identification information.

### BRIEF DESCRIPTION OF THE DRAWING

FIG. 1 is a diagram illustrating an example in which an apparatus for communicating with an RFID tag of this embodiment in the present invention is applied to management of book materials stored in a cabinet;

FIG. 2 is a system configuration diagram illustrating an outline of a reader;

FIG. 3 is a plan view illustrating an entire appearance of the reader;

FIG. 4 is a functional block diagram illustrating a detailed configuration of a CPU, an RF communication control part, and a reader antenna in the reader;

FIG. 5 is a block diagram illustrating an example of a functional configuration of an RFID tag circuit element disposed in an RFID tag;

FIG. 6 is a diagram illustrating an example of a time chart of a signal transmitted and received between the reader and the single RFID tag;

FIG. 7A is a table conceptually illustrating a registration tag list that manages tag IDs and material names of the book materials in association with each other;

FIG. 7B is a table conceptually illustrating a detection tag list created by extraction from the registration tag list;

FIG. 8 is a flowchart illustrating a control procedure executed by the CPU of the reader when a plural tag detection function is selected;

FIG. 9 is a flowchart illustrating a detailed procedure of an individual tag ID detection processing executed at Step S100 in FIG. 8;

FIG. 10 is a flowchart illustrating a detailed procedure of an all specification tag IDs detection processing executed at Step S200 in FIG. 8;

FIG. 11 is a flowchart illustrating a detailed procedure of a single tag detection mode executed at Step S300 in FIGS. 9 and 10;

FIG. 12A is a diagram illustrating a display example of a liquid crystal panel during operation of the reader;

FIG. 12B is a diagram illustrating a display example of the liquid crystal panel during operation of the reader;

FIG. 12C is a diagram illustrating a display example of the liquid crystal panel during operation of the reader;

### DETAILED DESCRIPTION OF THE PREFERRED EMBODIMENTS

An embodiment of the present invention will be described below referring to the attached drawings. This embodiment is an example in which an apparatus for communicating with an RFID tag of the present invention is applied to management of book materials stored on cabinet, for example.

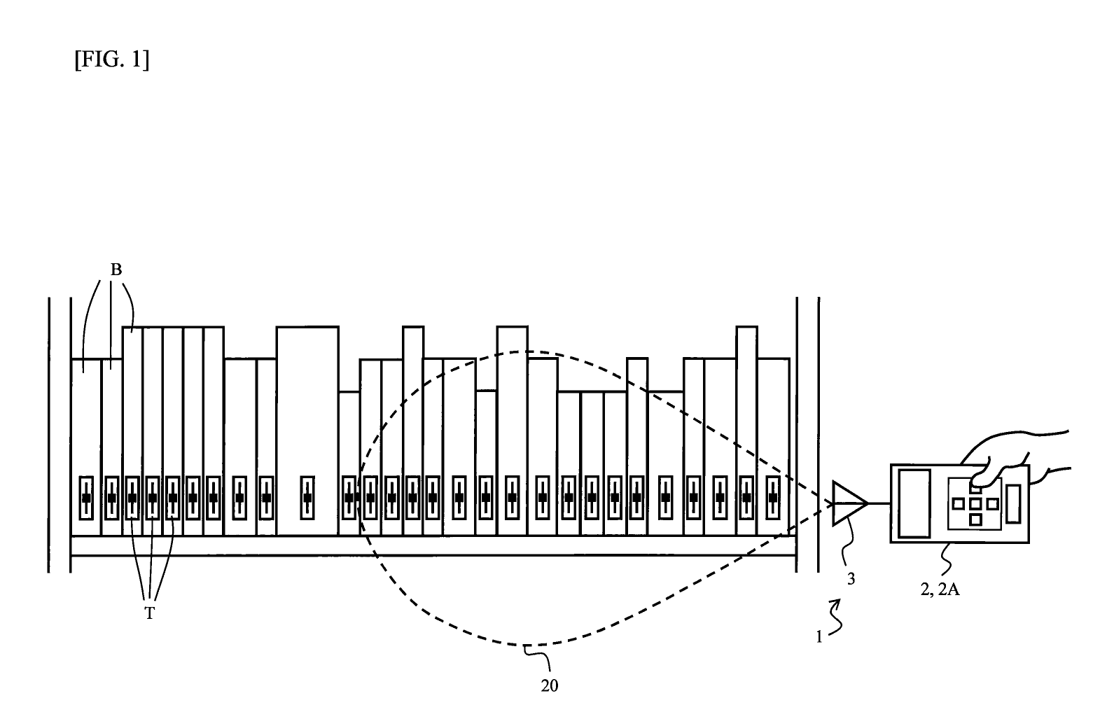

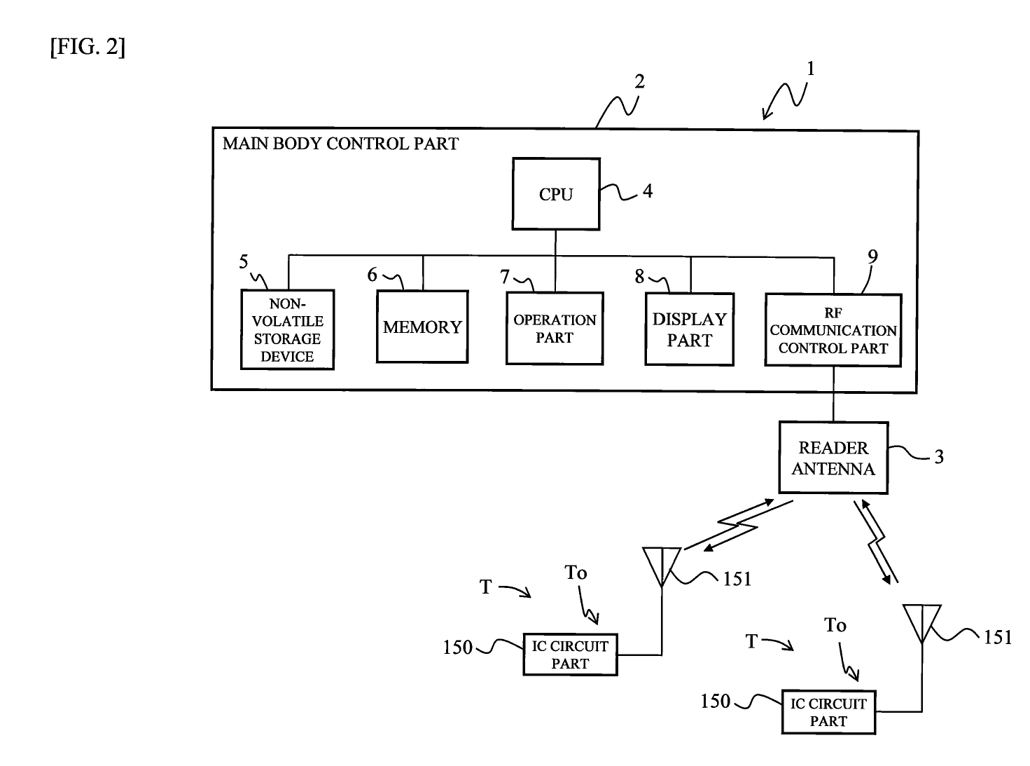

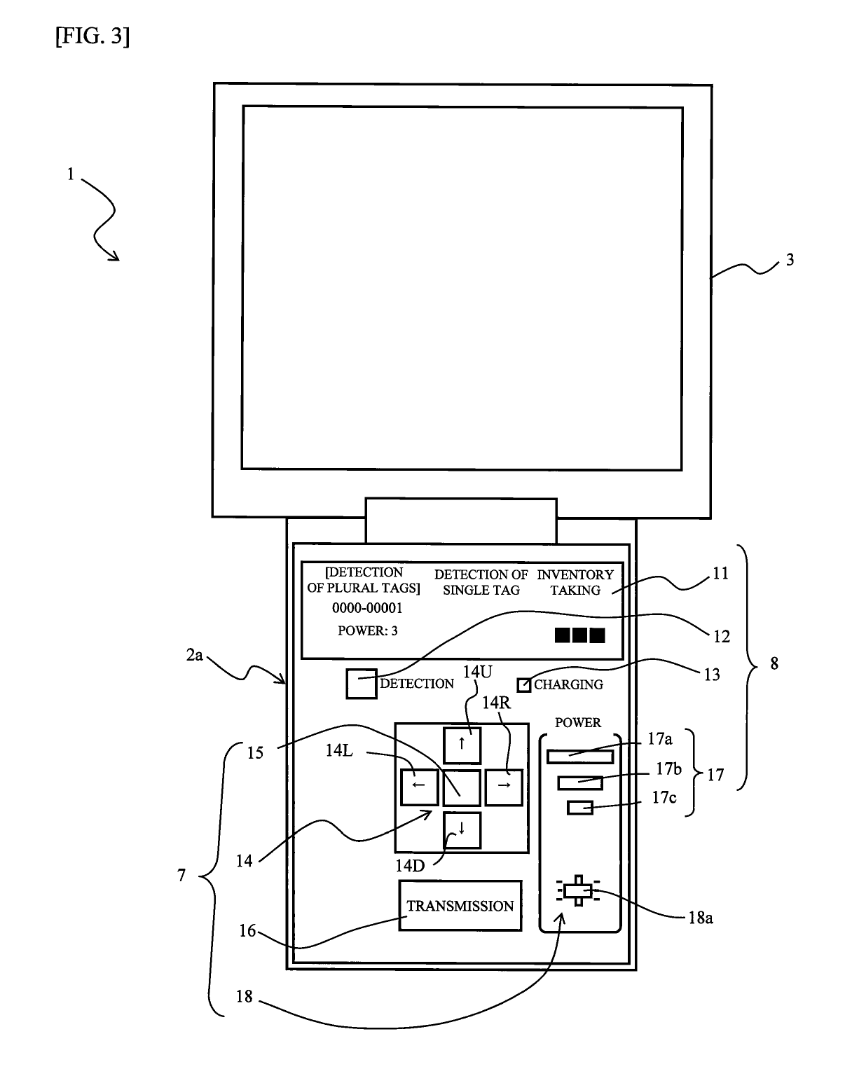

In FIG. 1, in this embodiment, a plurality of book materials B as articles are stored on a single shelf plate in a cabinet. The book materials (hereinafter simply referred to as a “book”) B are aligned in a horizontal direction, which is a right and left direction in the figure, in a vertically placed mode with their spine labels placed in a perpendicular direction. The RFID tag T is attached to each book B. A reader 1, which is an apparatus for communicating with an RFID tag of this embodiment, is a handheld type. On a housing of the reader 1, an operation part 7 and a display part 8 (See FIGS. 2 and 3, which will be described later) are disposed.

A user of the reader 1 is a person who is taking out the required book B. The user makes input setting of a list of the single or plural books B to be taken out in the reader 1 in advance through the operation part 7. Alternatively, the user may make the input setting from another terminal or information equipment via wired communication through a USB cable, for example, or radio communication such as wireless LAN. After that, the user takes the reader 1 in hand and moves the reader 1 from one side end portion to the other side end portion of a row of the plurality of books B aligned as above. The reader 1 transmits and receives information to and from the RFID tag T attached to each book B via radio communication and searches an arrangement position of each book B set in the list.

Here, a communicable area 20 of the reader 1 shown by a broken line in the figure is a peripheral area of the reader 1 spread from the reader antenna 3 as a base point. A range of the communicable area 20 is limited by directivity of the reader antenna 3 or output power as a power. The output power is so-called aerial power. The reader 1 determines availability of reception of identification information from the RFID tag T of the targeted book B while changing the communicable area 20 in a stepped manner. As a result, the reader 1 can detect a distance from the reader 1 to the targeted book B and search an approximate arrangement position of the book B on the shelf plate.

In FIG. 2, the reader 1 reads information stored in the RFID tag T attached to each book B via radio communication.

The reader 1 has a main body control part 2 and the reader antenna 3 as a radio communication device. The main body control part 2 includes a CPU 4, a non-volatile storage device 5 such as a hard disk device or a flash memory, a memory 6 such as a RAM and a ROM, the operation part 7, the display part 8, and a radio frequency (RF) communication control part 9 as a radio communication device. The non-volatile storage device 5 stores information relating to all the books B. In the operation part 7, an instruction and information from the user is inputted. The display part 8 displays various kinds of information and messages. The RF communication control part 9 controls radio communication with the RFID tag T through the reader antenna 3. The non-volatile storage device 5 and the memory 6 constitute a storage device described in each claim.

The CPU 4 executes signal processing according to a program stored in the ROM in advance using a temporary storage function of the RAM. The CPU 4 executes various control of the entire reader 1.

The RFID tag T has an RFID tag circuit element To provided with a tag antenna 151 and an IC circuit part 150. By disposing the RFID tag circuit element To on a base material, not particularly shown, the RFID tag T can be attached to an article such as the book B.

An appearance of the reader 1 is shown in FIG. 3. The reader 1 integrally includes a housing 2a of the main body control part 2 formed substantially in the shape of a rectangular solid and the reader antenna 3. The reader antenna 3 is disposed at one end portion of the housing 2a in the longitudinal direction or an upper end portion in this example. In this example, the communicable area 20 of the reader 1 is formed along an extension in the longitudinal direction of the housing 2a from the reader antenna 3, that is, extends to an upper direction in FIG. 3. In an example shown in FIG. 1, the user performs search processing while holding the housing 2a in hand and directing the reader antenna 3 toward the plurality of the books B.

On a plane on one side of the housing 2a, that is, on a face on the illustrated front side, a liquid crystal panel 11, a detection lamp 12, a charging lamp 13, four direction keys 14U, 14D, 14L, 14R constituting one of selection operating devices, a determination key 15 constituting one of the selection operating devices, a transmission key 16, a power indicator 17, and a transmission intensity adjusting slider 18 are disposed. The liquid crystal panel 11 is arranged on an upper side in the figure. The detection lamp 12 and the charging lamp 13 are arranged on a lower side in the figure of the liquid crystal panel 11. The determination key 15 is arranged at the center of the four direction keys 14U, 14D, 14L, 14R. The transmission key 16 is arranged on the lower side of the figure. The power indicator 17 is arranged on the right side of the direction keys 14U, 14D, 14L, 14R. The transmission intensity adjusting slider 18 is arranged on the right side of the transmission key 16.

The four direction keys 14U, 14D, 14L, 14R, the determination key 15, the transmission key 16, and the transmission intensity adjusting slider 18 among these parts constitute the operation part 7. The liquid crystal panel 11, the detection lamp 12, the charging lamp 13, and the power indicator 17 constitute the display part 8.

The liquid crystal panel 11 displays switching states of various functions executed by the reader 1 and various kinds of information and messages in these functions in letters and symbols. Also, the liquid crystal panel 11 displays a charged state of a battery, not shown, of the reader 1 by means of an indicator. In the reader 1, three modes of functions: “plural tag detection function”, “single tag detection function” and “inventory-taking function” are prepared. The illustrated display example displays a state in which the “plural tag detection function” among them has been selected. Also, the illustrated display example displays a state in which the battery charged state is “3” in three stages and three square frames are painted.

In processing executed by the single tag position detection function, only one RFID tag T or the book B to which the RFID tag T is attached is specified, and the reader 1 continues communication to inquire whether or not the RFID tag T is within a range of the maximum communicable area 20 of the reader 1 all the time. This processing is executed in a “single tag detection mode”, which will be described later. At this time, with respect to the specified single RFID tag T, the reader 1 changes the communicable area 20 from the minimum range to the maximum range in a stepped manner. Also, the reader 1 determines availability of radio communication with the specified RFID tag T in each stage, by which the minimum communicable area capable of radio communication is detected. On the basis of a power corresponding to the minimum communicable area, the reader 1 detects an approximate separation distance from the reader 1 to the RFID tag T.

Processing executed by the plural tag detection function is executed in a “plural tag detection mode” or in a “response determination mode”, which will be described later and the “single tag detection mode”. That is, first, in the plural tag detection mode, the plurality of RFID tags T or corresponding plurality of books B are specified, and the reader 1 continues communication to inquire whether or not a plurality of the RFID tags T are present in a range of the maximum communicable area 20 of the reader 1 all the time. At this time, a detection tag list listing identification information of the specified plurality of RFID tags T (hereinafter referred to as a tag ID) is prepared in advance. The reader 1 confirms that the RFID tag T of the book B corresponding to each tag ID described in the detection tag list is present in the range of the maximum communicable area 20 of the reader 1, respectively. Alternatively, in the response determination mode, the reader 1 obtains tag information including the respective tag IDs from all the RFID tags T in the communicable area of the reader 1 without specifying the RFID tag T as above. Then, the reader 1 extracts and obtains only the tag ID described in the detection tag list from the obtained tag IDs. As described above, during execution of the plural tag detection mode or the response determination mode, if the reader 1 detects the RFID tag T having any of the tag ID described in the detection tag list, the mode of the reader 1 is switched to the single tag detection mode. That is, the reader 1 executes the processing similar to the processing executed by the single tag detection function to each RFID tag T. The reader 1 specifies only one RFID tag T or the book B to which the RFID tag T is attached and continues communication to inquire whether or not the RFID tag T is present in the range of the maximum communicable area 20 of the reader 1 all the time. Then, the reader 1 detects an arrangement position of each RFID tag T on the shelf plate, that is, a separation distance from the reader 1. Detailed contents of the plural tag detection mode, the response determination mode, and the single tag detection mode will be described later in more detail.

In processing executed by the inventory-taking function, the reader 1 reads the tag IDs of only those plurality of RFID tags T specified in advance in order to determine only if they can be detected or not. In this processing, only presence of the RFID tag T matters, and the processing is finished at the time when all the tag IDs of the specified plurality of RFID tags T have been read.

In FIG. 3, the detection lamp 12 and the charging lamp 13 are both display function parts using light-emitting elements such as an LED. The detection lamp 12 displays presence of detection of the specified RFID tag T by a difference between being lighted and not lighted. The charging lamp 13 displays a charged state of the battery by a difference between being lighted and not lighted.

The power indicator 17 includes LEDs 17a, 17b, 17c, which are three light-emitting elements aligned vertically in the figure in this example. The power indicator 17 displays magnitude of the power in a stepped manner by the number of lighted LEDs 17a to 17c. The power indicator 17 makes display in three steps in the illustrated example.

The four direction keys 14U, 14D, 14L, 14R arranged in a cross shape are assigned capable of directing vertical and horizontal directions corresponding to a positional relation to the center of the cross arrangement, respectively. The direction keys 14U, 14D, 14L, 14R are press-in type key switches and used for a movement instruction of a cursor displayed on the liquid crystal panel 11 or a selection instruction of a plurality of options. The determination key 15 arranged at the center of the four direction keys 14U, 14D, 14L, 14R is used for a determination instruction of such a selection.

The transmission key 16 is a key switch used to instruct start of transmission of various instruction commands and information to the RFID tag T via radio communication.

The transmission intensity adjusting slider 18 is a slider-type switch that can move a position of a knob 18a vertically in the figure in a stepped manner. The user can make fine adjustment of the intensity of a radio wave outputted from the reader antenna 3, that is, a power using the transmission intensity adjusting slider 18.

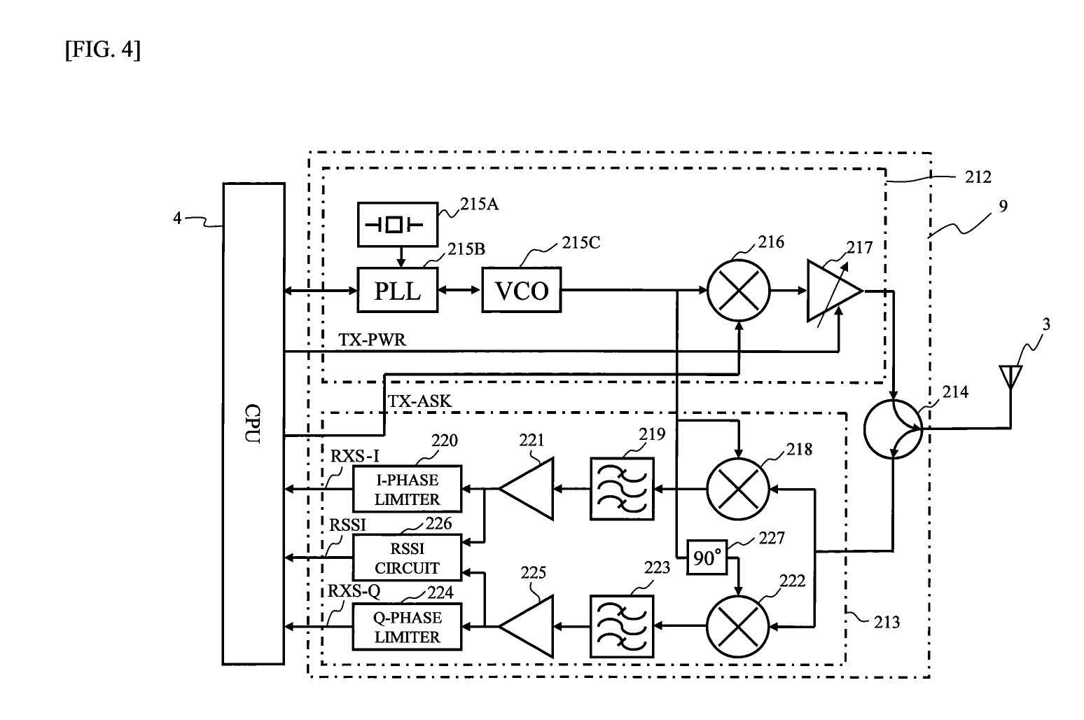

As shown in FIG. 4, the RF communication control part 9 of the reader 1 accesses information containing the tag ID stored in the IC circuit part 150 of the RFID tag circuit part To through the reader antenna 3.

The CPU 4 processes a signal read of the IC circuit part 150 of the RFID tag circuit part To so as to read information and also generates various commands to access the IC circuit part 150 of the RFID tag circuit part To. The details will be described later.

The RF communication control part 9 includes a transmitting portion 212, a receiving portion 213, and a transmit-receive splitter 214.

The transmitting portion 212 is a block configured to generate an interrogation wave to access RFID tag information of the IC circuit part 150 of the RFID tag circuit part To through the reader antenna 3. The transmitting portion 212 is provided with a crystal oscillator 215A, a Phase Locked Loop (hereinafter referred to as a “PLL”) 215B, a Voltage Controlled Oscillator (hereinafter referred to as a “VCO”) 215C, a transmission multiplying circuit 216, and a gain control transmission amplifier 217.

The crystal oscillator 215A outputs a reference signal of a frequency. The PLL 215B generates a carrier wave with a predetermined frequency by dividing and multiplying an output of the crystal oscillator 215A by means of control of the CPU 4. The VCO 215C outputs a carrier wave with a frequency determined based on a control voltage generated by the PLL 215B. As the frequency of the generated carrier wave, a UHF band, a micro wave band or a short-wave band frequency, for example, is used.

The transmission multiplying circuit 216 modulates the carrier wave generated based on the signal supplied from the CPU 4. In this example, the transmission multiplying circuit 216 executes amplitude modulation on the basis of a “TX_ASK” signal from the CPU 4. In the case of such amplitude modulation, an amplification rate variable amplifier, for example, may be used instead of the transmission multiplying circuit 216.

The gain control transmission amplifier 217 amplifies the modulated wave modulated by the transmission multiplying circuit 216. In this example, the gain control transmission amplifier 217 performs amplification with an amplification rate determined by a “TX_PWR” signal from the CPU 4. The output of the transmission amplifier 217 is transmitted to the reader antenna 3 through the transmit-receive splitter 214, radiated from the reader antenna 3 as an interrogation wave and supplied to the IC circuit part 150 of the RFID tag circuit part To. The interrogation wave is not limited to the modulated signal, that is, the modulated wave as above, but the wave might be a simple carrier wave.

The receiving portion 213 receives an input of a response wave from the RFID tag circuit part To received by the reader antenna 3. The receiving portion 213 is provided with an I-phase receiving signal multiplying circuit 218, an I-phase band-pass filter 219, an I-phase receiving signal amplifier 221, an I-phase limiter 220, a phase shifter 227, a Q-phase receiving signal multiplying circuit 222, a Q-phase band-pass filter 223, a Q-phase receiving signal amplifier 225, a Q-phase limiter 224, and a Received Signal Strength Indicator (hereinafter referred to as an “RSSI”) circuit 226 as intensity detecting device.

The I-phase receiving signal multiplying circuit 218 multiplies and demodulates the response wave from the RFID tag circuit part To received by the reader antenna 3 and inputted through the transmit-receive splitter 214 and a band-pass filter 227 and the generated carrier wave.

The I-phase band-pass filter 219 takes out only a signal in a required band from the output of the I-phase receiving signal multiplying circuit 218. The I-phase receiving signal amplifier 221 amplifies an output of the I-phase band-pass filter 219. The I-phase limiter 220 further amplifies the output of the I-phase receiving signal amplifier 221 and converts it to a digital signal.

The phase shifter 227 delays a phase of the carrier wave generated as above by 90°. The Q-phase receiving signal multiplying circuit 222 multiplies the response wave from the RFID tag circuit part To received at the reader antenna 3 and the carrier wave whose phase is delayed by the phase shifter 227 by 90°. The Q-phase band-pass filter 223 takes out only a signal in a required band from the output of the Q-phase receiving signal multiplying circuit 222. The Q-phase receiving signal amplifier 225 amplifies an output of the Q-phase band-pass filter 223. The Q-phase limiter 224 further amplifies the output of the Q-phase receiving signal amplifier 225 and converts it to a digital signal.

A signal “RXS-I” outputted from the I-phase limiter 220 and a signal “RXS-Q” outputted from the Q-phase limiter 224 are inputted into the CPU 4 and processed. The outputs from the I-phase receiving signal amplifier 221 and the Q-phase receiving signal amplifier 225 are also inputted into the RSSI circuit 226 and a signal “RSSI” indicating the intensity of these signals is inputted into the CPU 4. As above, the reader 1 demodulates the response wave from the RFID tag circuit part To by I-Q quadrature demodulation.

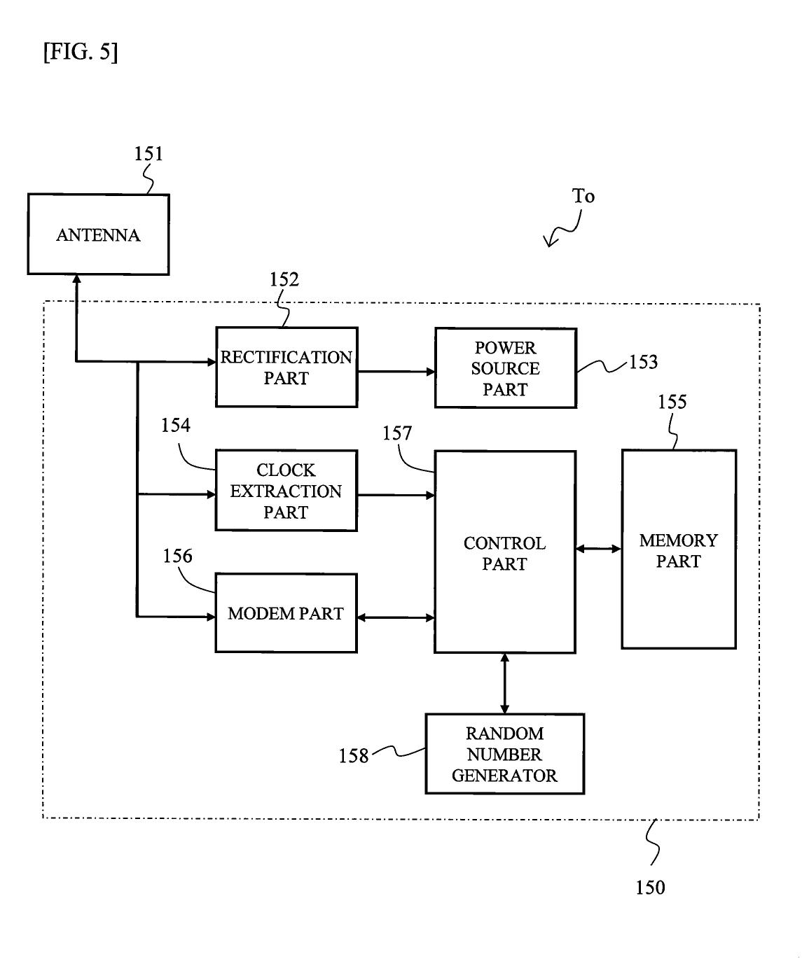

The RFID tag circuit element To has, as shown in FIG. 5, the tag antenna 151 performing transmission and reception of a signal in a non-contact manner with the reader antenna 3 of the reader 1 via radio communication or electromagnetic induction and the IC circuit part 150 connected to the tag antenna 151.

The IC circuit part 150 is provided with a rectification part 152, a power source part 153, a clock extraction part 154, a memory part 155, a modem part 156, a random number generator 158, whose details will be described later, and a control part 157. The rectification part 152 rectifies an interrogation wave received by the tag antenna 151. The power source part 153 accumulates energy of the interrogation wave rectified by the rectification part 152 and uses the energy as a driving power source of the RFID tag circuit element To. The clock extraction part 154 extracts a clock signal from the interrogation wave received by the tag antenna 151 and supplies the signal to the control part 157. The memory part 155 stores a predetermined information signal. The random number generator 158 generates a random number when the interrogation wave as an interrogation signal from the reader 1 is received. To which identification slot a response wave as a response signal should be outputted is determined by the random number. The control part 157 controls operations of the RFID tag circuit element To through the memory part 155, the clock extraction part 154, the random number generator 158, and the modem part 156, for example.

The modem part 156 demodulates an interrogation wave from the reader antenna 3 of the reader 1, received by the tag antenna 151. The modem part 156 also modulates a reply signal from the control part 157 and transmits it as a response wave, that is, a signal including the tag ID, from the tag antenna 151.

The clock extraction part 154 extracts a clock component from the received signal and supplies a clock corresponding to a frequency of the clock component of the received signal to the control part 157.

The random number generator 158 generates a random number from 0 to 2^{Q}−1 to a slot number specified value Q specified in the interrogation signal from the reader 1. The details will be described later.

The control part 157 interprets a received signal demodulated by the modem part 156 and generates a reply signal on the basis of the information signal stored in the memory part 155. Then, the modem part 156 transmits the reply signal through the tag antenna 151 in an identification slot corresponding to the random number generated by the random number generator 158.

In the memory part 155, a tag ID is stored in advance as identification information to specify an individual RFID tag circuit element To. The tag ID is uniquely set to each RFID tag circuit element To so that the same two or more IDs are not duplicated.

Here, the most distinctive characteristic of the reader 1 of this embodiment is processing contents executed in the plural tag detection function to search the respective arrangement positions of the plurality of RFID tags T. That is, in this processing, first, the reader 1 estimates the estimation number X, which is the number of all the RFID tags T in the communicable area 20. Subsequently, the reader 1 performs the plural tag detection mode and the response determination mode by switching between them on the basis of the estimation number X of all the RFID tags T. As described above, in the plural tag detection mode, processing is executed in which tag information including the tag ID is individually obtained from the corresponding RFID tag T while the plurality of tag IDs in the detection tag list are sequentially specified. Also, in the response determination mode, after the tag information including the respective tag IDs from all the RFID tags T in the communicable area 20 of the reader 1 is obtained, processing to obtain only the plurality of tag IDs in the detection tag list from them is executed. After that, in the single tag detection mode, the reader 1 specifies the RFID tag T whose presence has been confirmed and searches its arrangement position individually. The details will be sequentially described below.

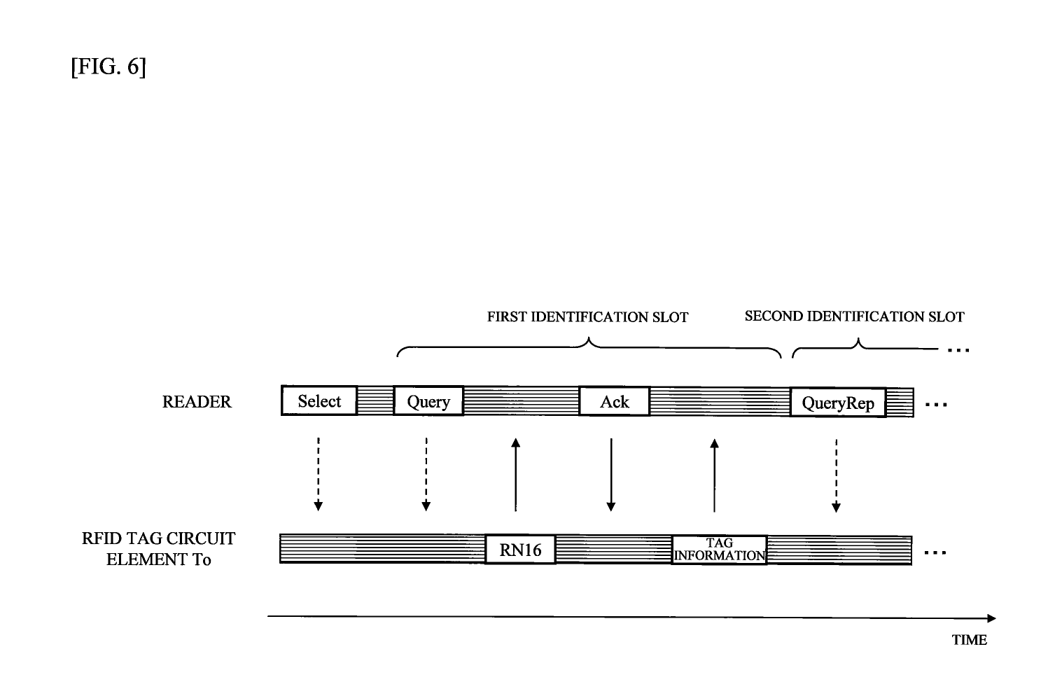

First, a signal transmitted and received between the reader 1 and the RFID tag T and a method of transmission and reception thereof will be described using the international standard ISO/IEC 18000-6 Type C protocol as an example using FIG. 6.

The method of transmitting and receiving a signal shown in FIG. 6 is based on the known Random-Slotted Collision arbitration method. A change over time from the left side to the right side is shown in the figure. Also, arrows shown between the reader 1 and the RFID tag T indicate a transmission direction of the signal. A broken line indicates a case in which the other party of transmission is unspecified, while a solid line indicates a case in which the other party of transmission is specified.

In FIG. 6, the reader 1 first transmits a “Select” command to all the RFID tags T present in the communicable area 20. This “Select” command is a command to specify a condition of the RFID tag T with which the reader 1 conducts radio communication after that. By using this command, various conditions such as tag ID are specified and the number of RFID tags T whose information is to be read is limited so that efficiency of the radio communication can be improved. Only the RFID tag T satisfying the specified conditions in the RFID tags T having received the “Select” command can conduct radio communication after that. In FIG. 6, only one RFID tag T satisfying the conditions is shown. As will be described later, if this “Select” command is transmitted without specifying condition at all, all the RFID tags T present in the communicable area of the reader 1 can be made reading targets, that is, all tags specification.

Subsequently, the reader 1 transmits a “Query” command as a reading command to request response transmission of the respective tag information including tag information to the same RFID tag group. This “Query” command includes a slot number specified value Q to specify with any of values from 0 to 15 in this example. If the “Query” command is transmitted from the RF communication control part 9 through the reader antenna 3, each of the RFID tag circuit elements To of the RFID tag T having received the command creates random numbers from 0 to 2^{Q}−1, that is, up to Q power of 2−1 by the random-number generator 158. The RFID tag circuit element To maintains the created random numbers as slot count values S.

Immediately after transmitting the “Query” command through the reader antenna 3, the reader 1 waits for a response from the RFID tag circuit element To in a desired identification slot. This identification slot is a timeframe divided in a predetermined period after the “Query” command or a “QueryRep” command, which will be described later, is first transmitted. This identification slot is usually repeated continuously for a desired number of times. In this example, a single session of a first identification slot of the “Query” command and 2^{Q}−1 sessions of a second identification slot and after of the “QueryRep” command, totaling in 2^{Q} times, are repeated.

Then, as in the illustrated example, the RFID tag circuit element To having created a value 0 as the slot count value S responds in the first identification slot containing this “Query” command. At this time, the RFID tag circuit element To transmits an “RN16” command using a pseudo random number of 16 bits, for example, in order to obtain permission to transmit the tag information to the reader 1 as a response signal.

Then, the reader 1 having received the “RN16” command transmits an “Ack” command to permit transmission of the tag information with the contents corresponding to the “RN16” command. The RFID tag circuit element To having received the “Ack” command determines if the received “Ack” command corresponds to the “RN16” command transmitted by the RFID circuit element To before. If it is determined that the “RN16” command corresponds to the “Ack” command, the RFID tag circuit element To considers that the transmission of its own tag information is permitted and transmits the tag information containing the tag ID. As described above, transmission and reception of a signal in a single identification slot is performed.

After that, at the second identification slot and after, the reader 1 transmits the “QueryRep” command instead of the “Query” command. Then, the reader 1 waits for a response of the other RFID tag circuit elements To, not shown, in the identification slot timeframe disposed immediately after that. Each RFID tag circuit element To having received the “QueryRep” command subtracts its own slot count value S only by 1 and maintains the value. Each RFID tag circuit element To conducts transmission and reception of a signal including the “RN16” command with the reader 1 in the identification slot at the time when the slot count value S becomes a value 0 as similarly to the above.

In each identification slot, if there is no RFID tag circuit element To with the slot count value S of 0, transmission and reception is not conducted except the “Query” command or “QueryRep” command, and after a predetermined timeframe has elapsed, the identification slot is finished.

As described above, each RFID tag circuit element To replies a response signal in a different identification slot. As a result, the reader 1 is not affected by interference but can clearly receive and take in the tag information of the respective RFID tag circuit elements To through the reader antenna 3.

Here, there are three response states that can occur in each of the plurality of identification slots, that is, a no response state, a normal response state, and a collision state.

The no response state is a state in which there is no RFID tag circuit element To with the slot count value S of 0 in the identification slot. In this state, since there is no response at all from the RFID tag circuit element To, transmission and reception of the “RN16” command, the “Ack” command, and the “tag information” is not conducted between the reader 1 and the RFID tag circuit element To. The normal response state is a case in which there is only one RFID tag circuit element To with the slot count value S of 0 in the identification slot. In this state, transmission and reception of the “RN16” command, the “Ack” command, and the “tag information” is normally conducted between the reader 1 and the RFID tag circuit element To as shown in the first identification slot in FIG. 6. The collision state is a case in which there are accidentally a plurality of the RFID tag circuit elements To with the slot count value S of 0 in the identification slot, though not particularly shown. In this state, as the result of collision of the plurality of “RN16” commands transmitted from the plurality of RFID tag circuit elements To, normal communication can no longer be available between the reader 1 and the RFID tag circuit element To.

In each identification slot, the communication state between the reader 1 and the RFID tag circuit element To is any one of the three states without fail. The RF communication control part 9 of the reader 1 can clearly specify and recognize which of the three states in each identification slot.

If the number of the RFID tags T whose tag information is to be read is relatively large with respect to the number of all the identification slots of 2^{Q} formed by the single “Query” command, a frequency of occurrence of the collision state is raised. On the other hand, if the number of all the identification slots and the number of the RFID tags T to be read are substantially equal, the frequency of collision is lowered, and a possibility of the normal response state is raised. Moreover, if the number of the RFID tags T to be read is sufficiently small as compared to the number of all the identification slots, most of the slots are brought into the no response state.

Here, in the Random-Slotted Collision arbitration method, there are mainly two types of methods for reading the tag ID, which is tag information, from each of the plurality of the RFID tags T, that is, an individual specification method and an all specification method.

The individual specification method is a method of repeating creation and transmission of the “Select” command and reading by the “Query” command immediately after transmission, that is, control by a set of two commands for the number of times equal to the number of the RFID tags T to be read. As described above, the “Select” command is a command to specify only one tag ID as a communication condition, while the “Query” command is a command to perform reading of the tag ID only from the specified RFID tag T. In this case, since the number of the RFID tag T to conduct radio communication is only one, the value of the identification slot number specified value Q to be included in the “Query” command may be set at “0”, and the number of all the identification slots at 2⁰, that is, 1.

With this individual specification method, the number of identification slots continuing to each “Query” command is only one. Therefore, if the number of tag ID detection times can be smaller than a predetermined number of times, time required for the entire processing can be relatively short, which is efficient. However, since the “Select” command in this method includes the tag ID, a command length of the “Select” command becomes longer. As a result, if the number of tag ID detection times is larger than the predetermined number of times, creation and transmission of a set of the “Select” command and the “Query” command are repeated for that portion, and the time required for the entire processing is relatively long, which is inefficient. In this embodiment, in the plural tag detection mode, the reader 1 reads the plurality of tag IDs by the individual specification method. The details will be described later.

The all specification method is a method of extracting the tag ID after creation and transmission of the “Select” command and reading by the “Query” command immediate after the transmission. That is, first, the reader 1 creates and transmits the “Select” command, which does not specify the communication condition but specifies all the tags. After that, the reader 1 reads the respective tag IDs from all the RFID tags T present in the communicable area of the reader 1 using the “Query” command including an appropriate slot number specified value Q. After that, the reader 1 selects and extracts the tag ID originally to be read from all the read tag IDs. Since the “Select” command in this method does not include the tag ID, the command length of the “Select” command is relatively short. The value of an appropriate slot number specified value Q to be included in the “Query” command in this case needs to be a value that can prepare the number of identification slots capable of receiving the tag ID with a sufficiently low collision rate from all the RFID tags T present in the communicable area 20 of the reader 1 at that time.

With this all specification method, if the number of all the RFID tags T in the communicable area 20 is relatively small, only by using the single “Select” command and the single “Query” command, the reader 1 can read the tag IDs of all the RFID tags T at once. Particularly, the reader 1 can read all the RFID tags T by means of rapid repetition of the simple “QueryRep” command and the identification slot made of a simple time section. As a result, the time required for the entire processing is relatively short, and efficient reading can be performed. However, in order to enable reading of the tag ID from the plurality of RFID tags T by the single “Query” command, the reader 1 needs to prepare the number of identification slots which is sufficiently larger than the number of all the RFID tags T in order to avoid collision of response signals from each of the RFID tags T. That is, the reader 1 sets the value of slot number specified value Q relatively large.

Thus, if a relatively large number of RFID tags T are present in the communicable area 20 of the reader 1, a large number of identification slots are needed in order to read the tag ID. In this case, the time for the reader 1 to execute the entire processing becomes extremely long, which is inefficient. In this embodiment, in the response determination mode, the plurality of tag IDs are read by the all specification method. The details will be described later.

The reader 1 of this embodiment executes processing to estimate the approximate total number of the RFID tags T in the communicable area, that is, number estimation processing in view of characteristics of the two specification methods. On the basis of the result, the reader 1 reads the tag ID from the RFID tag T to be detected in the communicable area 20. The number estimation processing will be described in detail later.

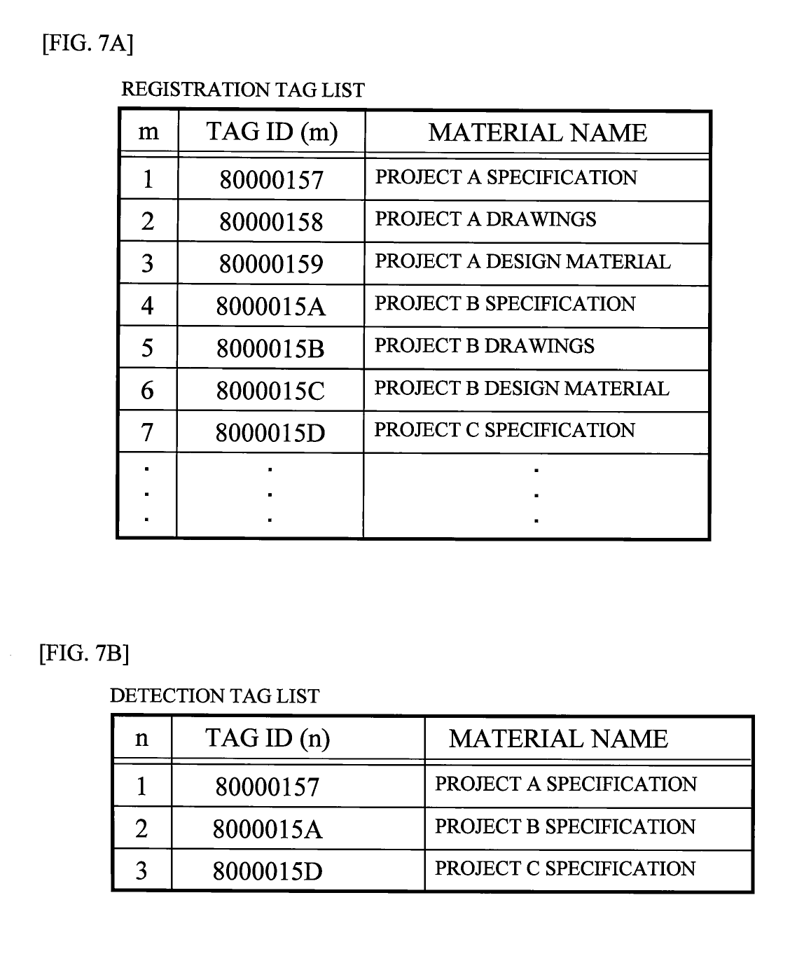

Subsequently, a registration tag list and a detection tag list created on the basis of the registration tag list recorded in the non-volatile storage device 5 of the reader 1 of this embodiment will be described using FIGS. 7A and 7B.

In FIG. 7A, in the registration tag list, names of all the books B arranged in the cabinet shown in FIG. 1 and tag IDs of all the RFID tags T attached to them are registered in association with reference numbers m, respectively. This list is prepared for each cabinet in advance.

The user of the reader 1 creates the detection tag list as a preparation state for searching positions of the plurality of RFID tags T, in other words, arrangement positions of the plurality of books B using the plural tag detection function. That is, the user creates the detection tag list as shown in FIG. 7B by selecting and extracting the book B to be searched in the registration tag list corresponding to the cabinet. In the illustrated example, only specifications of projects A, B, C are selected and extracted as search targets among the materials described in the registration tag list in FIG. 7A. The material names and tag IDs of the respective extracted specifications are stored in the detection tag list in a form of correlation information associated with the reference numbers n. In the following parts in the specification and figures, particularly the tag ID corresponding to the value of the reference number n in the detection tag list is called a tag ID(n). The created detection tag list is stored temporarily in the memory 6, for example. Alternatively, the detection tag list may be held and stored in the non-volatile storage device 5.

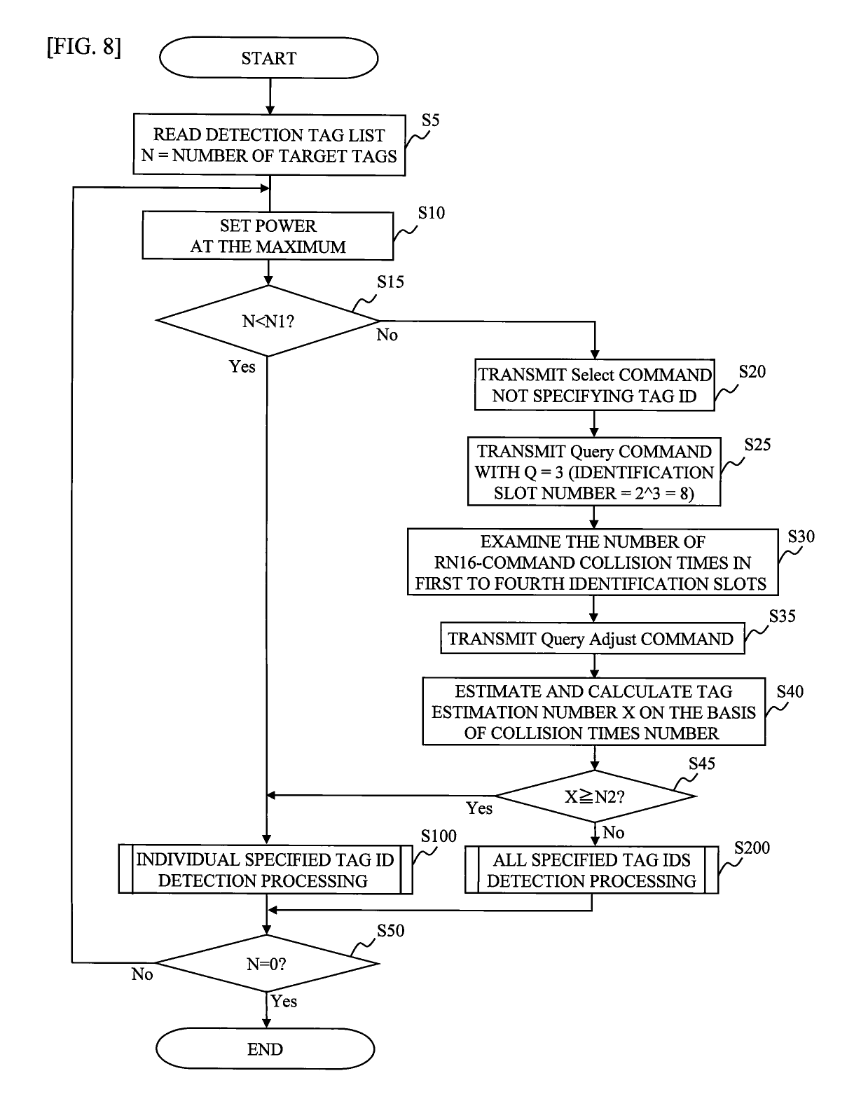

Subsequently, a control procedure executed by the reader 1 will be described referring to FIGS. 8 to 11. A flow shown in FIG. 8 is started if the detection tag list shown in FIG. 7B has been created in advance and the transmission key 16 is pressed down while the plural tag detection function has been selected.

First, at Step S5, the CPU 4 of the reader 1 reads the detection tag list from the memory 6 or the non-volatile storage device 5. Then, the CPU 4 sets the number of the books B or the tag IDs recorded in the detection tag list as a value of a variable N, and the routine goes on to the subsequent Step S10. In the example illustrated in FIG. 7B, the value of the variable N is represented by the maximum value of the reference number n, which is 3.

At Step S10, the CPU 4 outputs a control signal to the RF communication control part 9 so as to set the intensity of the power at the maximum. Specifically, the CPU 4 outputs the “TX_PWR” signal with the maximum value to the RF communication control part 9 and maximizes an amplification rate in the gain control transmission amplifier 217. As a result, output intensity of a radio wave transmitted from the reader antenna 3 is controlled to become the maximum (See FIG. 4). Thus, radio communication is enabled to all the RFID tags T present in the range of the maximum communicable area 20 of the reader 1 in the RFID tags T attached to each of all the books B.

At Step S15, the CPU 4 determines if the value of the variable N is smaller than a first threshold value N1 or not. Here, the first threshold value N1 is a reference value for performing reading for the purpose of presence confirmation of each tag efficiently in a short time. That is, the first threshold value N1 is a reference value to determine if the value of N, that is, the number of tags ID is small enough to select detection by the individual specification method or not. A value of the first threshold value N1 is set in advance at an appropriate value according to a time length of each command shown in FIG. 6 and time interval between the commands. If the value of the variable N is smaller than the first threshold value N1, the determination at Step S15 is satisfied, and the CPU 4 considers that selection of detection by the individual specification method results in efficient detection. As a result, the routine goes to Step S100.

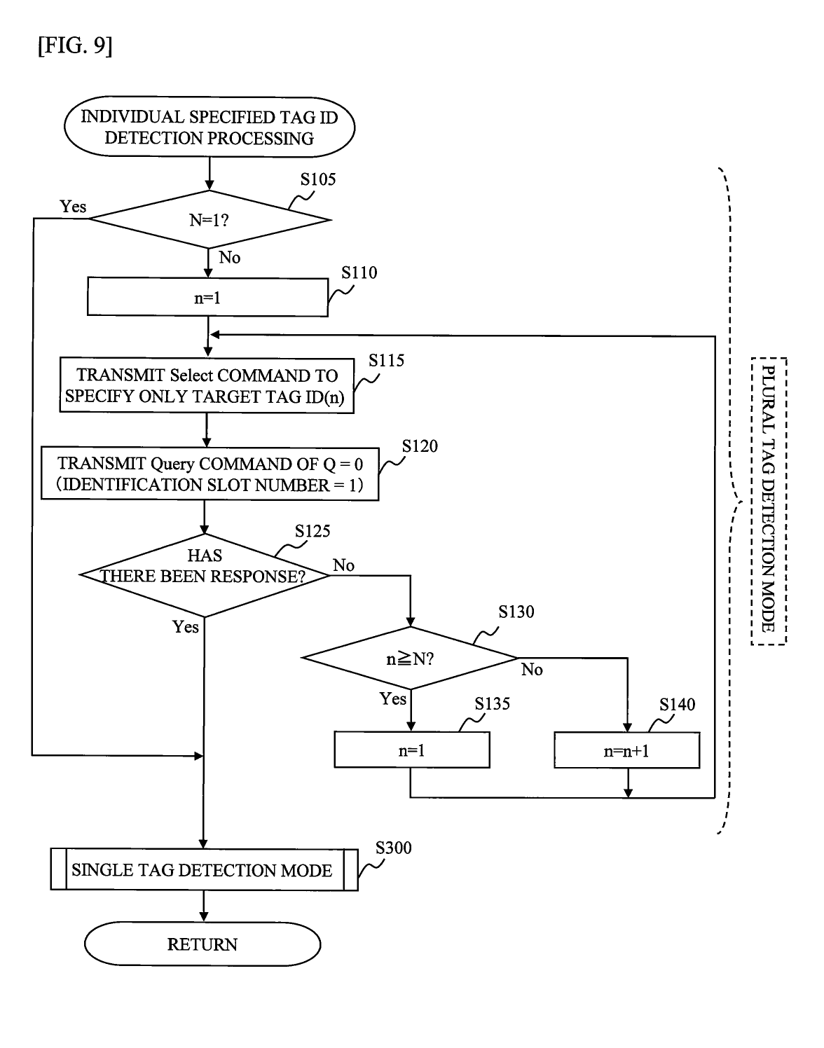

At Step S100, the CPU 4 executes individual specification tag ID detection processing. The details will be described referring to FIG. 9 later, but in this individual specification tag ID detection processing, the CPU 4 executes processing to detect all the tag IDs by the individual specification method. After that, the CPU 4 executes processing to detect the respective arrangement positions of all the RFID tags T corresponding to the tag IDs, that is, separation distances from the reader 1. Then, after the procedure at Step S100 is finished, Step S50, which will be described later, is executed, and this flow is finished.

On the other hand, at Step S15, if the value of the variable N is the threshold value N1 or more, the determination at Step S15 is not satisfied. In this case, the CPU 4 considers that the number of tag IDs(n) is too many to perform detection by the individual specification method, and the routine goes on to Step S20.

At Step S20, the CPU 4 creates the “Select” command specifying all the tag IDs as communication targets without specifying a specific tag ID and transmits it through the reader antenna 3. As a result, all the RFID tags T present in the range of the communicable area 20 which has been maximized by control at Step S10 at this time can become capable of the subsequent radio communication.

Subsequently, the routine goes to Step S25, and the CPU 4 creates the “Query” command with the value of the slot number specified value Q set at 3 in this example and transmits it through the reader antenna 3. By the value of the slot number specified value Q of 3, the number of identification slots is 2³, that is, 8. The value of the slot number specified value Q is a set value set and changed as appropriate according to the number of all the RFID tags T expected to be present in the communicable area 20 of the reader 1.

Subsequently, the routine goes to Step S30, and the CPU 4 examines the number of times to become a collision state of the “RN16” command in the first identification slot executed by the “Query” command and the second to fourth identification slots executed by the “QueryRep” command transmitted subsequent to the first identification slot. In this example, since it is necessary to examine only the number of collision state times, even in the normal response state in which the “RN16” command is received, the CPU 4 may omit transmission and reception of the subsequent “Ack” command and the “tag information”. Also, the CPU 4 does not have to examine the number of collision times in all the identification slot numbers set by the slot specified value Q. As in this example, the CPU 4 may examine the collision state only for the predetermined number of times, that is, the number of times for which the tag estimation number X, which will be described later, can be estimated with appropriate accuracy. In this case, the CPU 4 can omit examination of the collision state in the remaining identification slots, by which efficiency can be improved.

Subsequently, the routine goes to Step S35, and the CPU 4 creates a “QueryAdjust” command and transmits it through the reader antenna 3. The “QueryAdjust” command is a command to command to the RFID tag circuit elements To of all the RFID tags T having received the “Query” command from the reader 1 at Step S25 to reset all the settings such as the slot counter value S, for example. As a result, in the RFID tag circuit element To having received the “QueryAdjust” command, a standby state for the subsequent identification slot is released. That is, by transmitting the “QueryAdjust” command, the reading processing by the “Query” command at Step S25 is forcedly interrupted. In FIG. 6, the “QueryAdjust” command is not shown.

Subsequently, the routine goes to Step S40, and on the basis of the number of collision times of the “RN16” command examined at Step S30, the CPU 4 estimates and calculates the number of all the RFID tags T present in the communicable area of the reader 1 at that time, that is, the tag estimation number X. If the identification slot number is excessively short of the total RFID tags T to become radio communication targets, a collision of the “RN16” command occurs with an even frequency according to the degree of shortage over all the identification slots. Though detailed description and illustration are omitted, at Step S40, the CPU 4 makes estimation using the above-described contents. At that time, the CPU 4 makes the estimation, considering the all identification slot number, in other words, the value of the slot number specified value Q and the identification slot number obtained by examining the collision state among them, in other words, the above-described predetermined number of times together with the number of “RN16” command collision times.

Subsequently, the routine goes to Step S45, and the CPU 4 determines if the tag estimation number X calculated at Step S40 is a second threshold value N2 or more. Here, the second threshold value N2 is a reference value for performing reading to confirm presence of a tag efficiently in a short time. That is, the second threshold value is a reference value to determine if the estimation number of RFID tags T is large enough to select detection by the individual specification method or not. The value of the second threshold value N2 is also set in advance according to a time length of each command shown in FIG. 6 and a time interval between the commands.

If the estimation number X of the RFID tags T is equal to or larger than the second threshold value N2, the determination at Step S45 is satisfied. That is, the CPU 4 considers that if the number of RFID tags T is relatively large and detection is made by the all specification method, it becomes inefficient, and selection of detection by the individual specification method is more efficient. Then, the routine goes to Step S100. After the procedure at Step S100 is finished, the routine goes to Step S50.

On the other hand, if the estimation number X of the RFID tags T is less than the second threshold value N2, determination at Step S45 is not satisfied. That is, the CUP 4 considers that since the estimation number of RFID tags T is small and wasteful identification slots are fewer, selection of detection by the all specification method is more efficient. Then, the routine goes to Step S200.

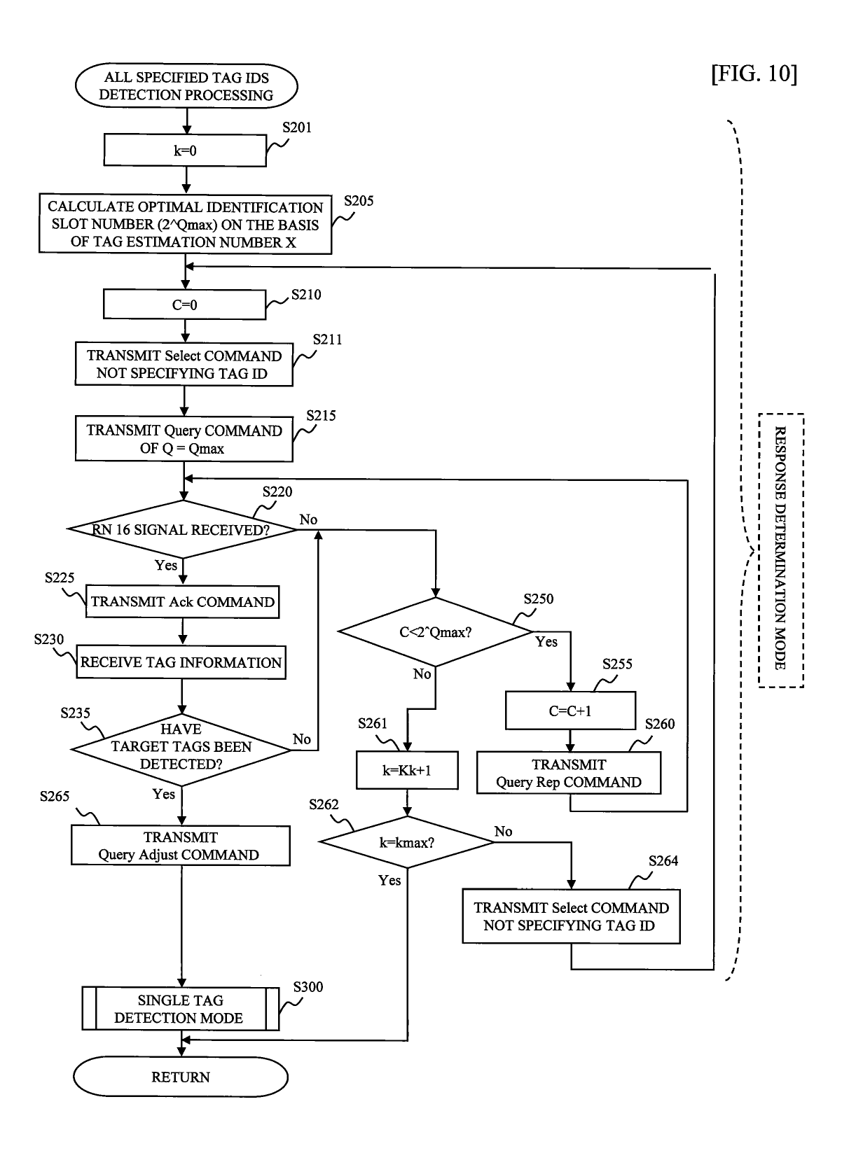

At Step S200, the CPU 4 executes the all specification tag IDs detection processing. The details will be described later referring to FIG. 10, but in this all specification tag IDs detection processing, the CPU 4 executes processing to detect all the tag IDs by the all specification method and detect the respective arrangement position of all the RFID tags T corresponding to the tag IDs, that is, the separation distances from the reader 1. After the procedure at Step S200 is finished, the routine goes to Step S50.

At Step S50, the CPU 4 determines if the number N of the detection target tags is 0 or not, that is, if all the tags as detection targets have been detected or not. If this determination is satisfied, this flow is finished, while if the determination is not satisfied, processing at Step S10 and after is repeated.

By executing the procedures by the flow as above, the CPU 4 executes the individual specification tag ID detection processing if the number of RFID tags T is small, while the CPU 4 executes the all specification tag IDs detection processing if the number of RFID tags T is large. In the respective processing, the CPU 4 can detect the respective arrangement positions of all the RFID tags T.

The individual specification tag ID detection processing will be described below referring to FIG. 9.

First at Step S105, the CPU 4 determines if the value of the variable N is 1 or not, that is, if the number of the RFID tags T recorded in the detection tag list is only one or not. If the value of N is 2 or more, that is, if there are a plurality of the RFID tags T, the determination at Step S105 is not satisfied, and the routine goes to the subsequent Step S110. If the value of N is 1, that is, if the number of RFID tag T is only 1, the determination is satisfied, and the routine goes to Step S300, which will be described later.

At Step S110, the CPU 4 sets the value of a variable n corresponding to the reference number of the detection tag list to 1. After that, the routine goes to the subsequent Step S115.

At Step S115, the CPU 4 creates the “Select” command to specify only the tag ID(n) with the reference number corresponding to the value of the variable n in the detection tag list and transmits it through the reader antenna 3. At this time, the power of the reader 1 is the maximum by the procedure at Step S10 in the flow in FIG. 8, and the communicable area 20 is in the maximum state. Therefore, all the RFID tags T present in the range of the maximum communicable area 20 of the reader 1 receive the “Select” command. As a result, only the RFID tag T whose ID(n) is stored in the memory part 155 of the RFID tag circuit element To in the RFID tags T attached to the plurality of books B arranged in the communicable area 20 of the cabinet can conduct the subsequent radio communication. That is, the RFID tag T with the tag ID(n) and the reader 1 can perform one-to-one information transmission and reception.

Subsequently, the routine goes to Step S120, and the CPU 4 creates the “Query” command with the slot number specified value Q of 0 and transmits it through the reader antenna 3. In this way, if the slot number specified value Q is set at 0, the identification slot number is 2⁰, that is, only one. The RFID tag circuit element To with the tag ID(n) having received this “Query” command creates 2^{Q}−1 as the slot count value S, that is, the value 0. As a result, when the RFID tag T with the tag ID(n) receives the “Query” command with the slot number specified value Q=0, the RFID tag T transmits to the reader 1 the “RN16” command as a response signal in the first identification slot immediately after that. Then, the RFID tag T continuously conducts transmission and reception of the “Ack” command and the “tag information including the tag ID” (See FIG. 6).

As described above, by executing the procedure at Step S115 and Step S120 by the CPU 4, the reader 1 conducts radio communication only with the specific single RFID tag T provided with the tag ID(n) among the large number of RFID tags T. That is, even with the Random-Slotted Collision arbitration method using the “Select” command and the “Query” command, the reader 1 can perform confirmation of presence of the RFID tag T and transmission and reception of information in the shortest time with the identification slot number of 1.

After that, the routine goes to Step S125, and the CPU 4 determines if the “RN16” command, which is a response signal to the “Query” command transmitted at Step S120 has been received or not. In other words, the CPU 4 determines if there has been a response from the RFID tag T whose tag ID is the tag ID(n) or not. If there has been no response, determination at Step S125 is not satisfied. That is, the CPU 4 considers that there is no RFID tag T with the tag ID(n) in the range of the maximum communicable area 20 of the reader 1 (See Step S10 in FIG. 8) or radio communication at Step S115 and Step S120 has failed, and the routine goes to the subsequent Step S130.

At Step S130, the CPU 4 determines whether or not the value of the variable n is the value of the variable N or more. If the value of the variable n is the value of the variable N or more, the determination at Step S130 is satisfied. That is, the CPU 4 considers that no response is obtained from any of the RFID tags T even if the ID(n) recorded in the detection tag list is sequentially called by the “Select” command and the “Query” command or that the communication has failed. Then, the CPU 4 returns the value of the variable n to 1 at Step S135. After that, the routine returns to Step S115 and repeats the similar procedure, and the CPU 4 conducts radio communication again from the first RFID tag T.

On the other hand, if the value of the variable n is smaller than the value of the variable N, the determination at Step S130 is not satisfied. In this case, the CPU 4 increments the value of the variable n by one at Step S140, and then, the routine returns to Step S115. The CPU 4 conducts radio communication to the subsequent RFID tag T in the detection tag list.

On the other hand, in the determination at Step S125, if there is a response from the RFID tag T with the tag ID(n), the determination at Step S125 is satisfied. That is, the CPU 4 considers that presence of the RFID tag T with the tag ID(n) in the range of the maximum communicable area 20 of the reader 1 can be confirmed, and the routine goes to the single tag detection mode at Step S300.

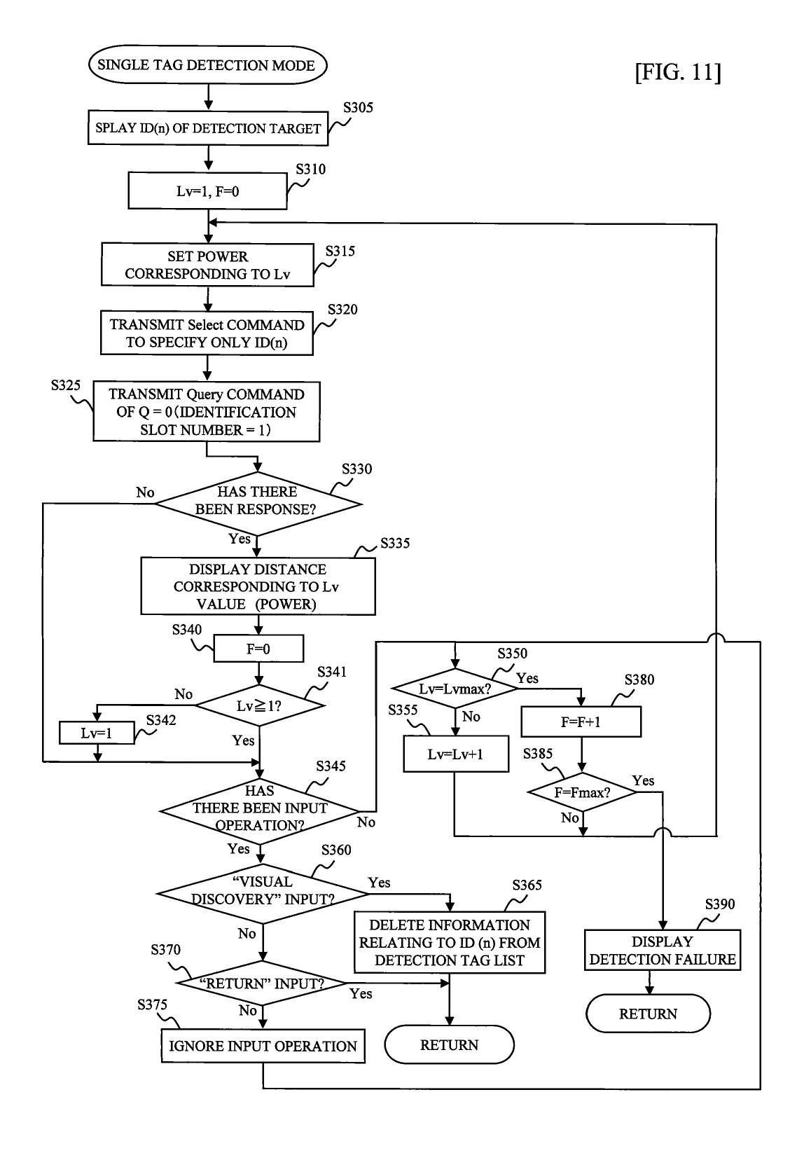

At Step S300 moved from Step S105 or Step S125, the CPU 4 executes the single tag detection mode. That is, the CPU 4 detects a separation distance from the RFID tag T to the reader 1 by conducting radio communication with the RFID tag T with the ID(n) (See FIG. 11, which will be described later).

After that, this flow is finished, and the CPU 4 returns to the flow shown in FIG. 8 and resumes the processing at Step S50 and after.

In the procedures of the flow shown in FIG. 9, Step S105 to Step S140 except Step S300 correspond to the plural tag detection mode described in each claim.

By performing the procedures in the above flow, if only one tag ID(n) is stored in the detection tag list, the CPU 4 immediately detects the arrangement position of the RFID tag T corresponding to the tag ID(n) in the single tag detection mode. If a plurality of tags ID(n) are stored in the detection tag list, the CPU 4 confirms if the RFID tags T corresponding to the respective tag ID(n) are present in the range of the maximum communicable area 20 of the reader 1 or not by the individual specification method. Then, the CPU 4 can detect the arrangement position of the RFID tag T whose presence was confirmed in the single tag detection mode.

The all specification tag IDs detection processing will be described referring to FIG. 10.

First, at Step S201, the CPU 4 sets a variable k to count the number of flow repetitions at 0. Then, at Step S205, the CPU 4 calculates the sufficient number of identification slots on the basis of the tag estimation number X estimated and calculated at Step S40 in the flow of FIG. 8. This sufficient number is a number of which the RFID tags T present in the maximum communicable area 20 of the reader 1 can reliably conduct information transmission and reception with all the RFID tags T without collision of the “RN16” command. Then, the CPU 4 calculates a slot number specified value Qmax corresponding to the identification slot number.

Subsequently, the routine goes to Step S210, and the CPU 4 sets a value of a counter variable C to become a reference variable of the identification slot at 1. After that, the routine goes to the subsequent Step S211.

At Step S211, the CPU 4 creates the “Select” command to specify all the tags ID as communication targets without specifying the specific tag ID and transmits it through the reader antenna 3. As a result, all the RFID tags T present in the range of the communicable area 20 of the reader 1, which is the maximum by control at Step S10 can conduct radio communication with the reader 1 after that.

After that, at Step S215, the CPU 4 creates the “Query” command with the slot number specified value Q=Qmax and transmits it through the reader antenna 3. At this time, the power of the reader 1 is the maximum by the procedure at Step S10 in the flow of FIG. 8, and the communicable area 20 of the reader 1 is the maximum. Also, the CPU 4 transmits the “Select” command not specifying the tag ID by the procedure at Step S211 in the case of k=0 executing this processing for the first and by the procedure at Step S264, which will be described later, after that. Therefore, in these cases, all the RFID tags T present in the maximum communicable area 20 of the reader 1 receive the “Query” command.

If the slot number specified value Q is set at Qmax as above, the number of 2̂Qmax of the identification slots are prepared in advance. However, it might be interrupted in the middle as will be described later. Also, the RFID tag circuit elements To of all the RFID tags T having received the “Query” command create random numbers of 0 to (2̂Qmax−1) as the slot count value S.

In the procedure at Step S30 in the flow of FIG. 8, the number of identification slots is limited to some degree in order to examine presence of collision or an empty slot. In this example, though the CPU 4 can prepare eight identification slots, it is limited to four identification slots. On the other hand, in the response determination mode, the reader 1 need to receive the response signals of all the RFID tags T in the communicable area 20. Thus, by increasing the slot number by the procedure at Step S30 in the flow of FIG. 8, the reader 1 can conduct smooth reception.

Subsequently, the routine goes to Step S220, and the CPU 4 determines if the “RN16” command as the response signal has been received or not from the RFID tag T with the slot count value S of 0 at this time. In this determination, if the “RN16” command has been received, the determination is satisfied. In this case, the CPU 4 considers that there is the RFID tag T responding in the identification slot, and the routine goes to the subsequent Step S225.

At Step S225, the CPU 4 transmits the “Ack” command with the contents corresponding to a pseudo random number contained in the “RN16” command received at Step S220. Then, at the subsequent Step S230, the CPU 4 receives and obtains the tag information including the tag ID, which is the identification information, from the RFID tag T. After that, the routine goes to the subsequent Step S235.

At Step S235, the CPU 4 determines if the tag ID received at Step S230 is any of the tag IDs stored in the detection tag list or not. If the received tag ID is the tag ID stored in the detection tag list, the determination is satisfied, and the routine goes to the subsequent Step S265.

On the other hand, if the “RN16” command has not been received yet in the determination at Step S220, the determination is not satisfied. In this case, the CPU 4 considers that there is no RFID tag T responding in the identification slot, and the routine goes to Step S250.

Also, on the other hand, in the determination at Step S235, if the received tag ID is not the tag ID stored in the detection tag list, the determination is not satisfied. In this case, the routine goes to Step S250.

As described above, at Step S220 or at Step S250 moved from Step S235, the CPU 4 determines if the value of the counter variable C is smaller than 2̂Qmax or not. In other words, the CPU 4 determines if the last identification slot has been finished or not. If the value of the counter variable C is smaller than 2̂Qmax, the determination at Step S220 is satisfied. In this case, the CPU 4 considers that the reading processing by the current “Query” command has not been finished yet, and the routine goes to the subsequent Step S255.

At Step S255, the CPU 4 adds 1 to the value of the counter variable C. After that, the CPU 4 transmits the “QueryRep” command at Step S260 from the reader antenna 3 so as to start the subsequent identification slot, returns to Step S220, and repeats the same procedure. The RFID tag circuit elements To of all the RFID tags T having received the “QueryRep” command subtract the value of the slot count value S stored by the memory part 155 by 1. As a result, the RFID tag T with the slot count value S which has become 0 transmits the “RN16” command in a new identification slot. Then, the reader 1 receives the “RN16” command at Step S220.

Also, on the other hand, in the determination at Step S250, if the value of the counter variable C is 2̂Qmax or more, the determination is not satisfied. In this case, the CPU 4 considers that the reading processing by the current “Query” command has been finished, that is, the last identification slot has finished while there is no response from any one of the RFID tags T recorded in the detection tag list or while communication fails. In this case, at Step S261, the CPU 4 adds 1 to a variable k indicating the number of all specification tag IDs detection processing times executed in the same state. After that, the CPU 4 determines at Step S262 if the variable k is equal to a specified value kmax or not. If this determination is satisfied, the CPU 4 finishes the all specification tag IDs detection processing shown in FIG. 10, returns to the flow shown in FIG. 8 and executes the processing at Step S50 and after. On the other hand, if the determination at Step S262 is not satisfied, the CPU 4 creates the “Select” command specifying all the tag IDs as communication targets without specifying the specific tag ID at Step S264 and transmits it through the reader antenna 3. After that, the CPU 4 returns to Step S210, repeats the same procedure and executes new reading processing from the first identification slot.

Also, on the other hand, if the determination at Step S235 is satisfied, the CPU 4 considers that the tag as the detection target has been detected, and the routine goes to the subsequent Step S265.

At Step S265, the CPU 4 transmits the “QueryAdjust” command to all the RFID tags T through the reader antenna 3 and forcedly interrupts the reading processing by the current “Query” command.

After that, the CPU 4 executes the single tag detection mode at Step S300 similarly to the above and conducts radio communication with the RFID tag T with the detected tag ID(n). As a result, the CPU 4 detects the separation distance from the RFID tag T to the reader 1 (See FIG. 11, which will be described later), and if this processing is completed, this flow is finished.

In the procedures in the flow shown in FIG. 10, Steps S201 to S265 except Step S300 correspond to the response determination mode described in each claim.

By executing the procedure in the above flow, the CPU 4 confirms if the RFID tags T corresponding to the plurality of tag IDs(n) stored in the detection tag list are present in the range of the maximum communicable area 20 of the reader 1 or not by the all specification method. As a result, the CPU 4 can detect the arrangement position in the single tag detection mode if presence of any of the RFID tag T can be confirmed.

Processing contents in the single tag detection mode will be described referring to FIG. 11.

First, at Step S305, the CPU 4 outputs a control signal to the display part 8 so as to display the contents of the tag ID(n) to be searched on the display part 8. At this time, the contents of the variable n keep the value in FIGS. 9 and 10. After that, at the subsequent Step S310, the CPU 4 initializes a value of a variable Lv corresponding to a level of the power to the minimum value 1. In this example, the variable Lv is changed in 10 steps of 1 to 10. Also, the CPU 4 initializes a value of a variable F corresponding to the number of detection failure times to 0.

Subsequently, the routine goes to Step S315, and the CPU 4 sets intensity of the power of the reader 1 corresponding to the value of the variable Lv. Specifically, similarly to the procedure at Step S10 in the flow of FIG. 8, the CPU 4 outputs the “TX-PWR” signal corresponding to the value of the variable Lv to the RF communication control part 9 and controls the amplification rate in the gain control transmission amplifier 217. As a result, corresponding to the change of the variable Lv in 10 steps from 1 to 10, the power of the reader 1 is controlled to be increased and decreased in 10 steps. In the case immediately after the variable Lv is initialized to 1 at Step S310, the power of the reader 1 is set to the lowest intensity. The power is increased corresponding to increase of the variable Lv and becomes the maximum if the variable Lv is 10 in the above example.

Then, at the subsequent Step S320, the CPU 4 transmits the “Select” command to specify only the tag ID(n) from the reader antenna 3. After that, the CPU 4 transmits the “Query” command with the slot number specified value Q of 0 from the reader antenna 3 at Step S325. In the procedures in these Steps S320 and S325, the CPU 4 executes the same control as in the procedures at Step S115 and Step S120 in the flow of FIG. 9. As a result, the CPU 4 performs calling, that is, a response request via radio communication in the shortest time only with the RFID tag T with the tag ID(n).

At the subsequent Step S330, the CPU 4 determines if there has been a response from the RFID tag T with the tag ID(n) similarly to the procedure at Step S125 in the flow of FIG. 9 or not. If there has been a response, the determination at Step S330 is satisfied. That is, the CPU 4 considers that there is the RFID tag T with the tag ID(n) in the range of the communicable area 20 of the reader 1 corresponding to the power of the variable Lv at that time, and the routine goes to the subsequent Step S335.

At Step S335, the CPU 4 calculates the separation distance from the reader 1 corresponding to the variable Lv at that time by a predetermined calculation. Then, the CPU 4 displays the distance as a numeral value, for example, on the display part 8. The function of this Step S335 constitutes an alarm device described in each claim. This display of the separation distance is display of a longest distance of the communicable area 20 of the reader 1 formed by the power corresponding to the variable Lv, that is, the separation distance from the reader antenna 3 to the distal end of the communicable area 20. In this display, a range from the reader 1 with a possibility that the RFID tag T with the tag ID(n) is present is shown.

Then, the routine goes to Step S340, and the CPU 4 re-sets the value of the variable F to 0. Moreover, the CPU 4 determines if the variable Lv is 1 or more at Step S341. If the determination at Step S341 is satisfied, the routine directly goes to the subsequent Step S345. If the determination at Step S341 is not satisfied, the CPU 4 sets the variable Lv to 1 at Step S342. After that, the routine goes to Step S345.

Also, on the other hand, in the determination at Step S330, if there has been no response from the RFID tag T with the tag ID(n), the determination is not satisfied. In this case, the CPU 4 considers that there is no RFID tag T with the tag ID(n) in the range of the communicable area 20 of the reader 1 corresponding to the power of the variable Lv at that time. Then, the routine goes to Step S345 without any change.

At Step S345, the CPU 4 determines if there has been any input operation from a user operating the reader 1 through the operation part 7 or not. If there has been no input operation, the determination is not satisfied, and the routine goes to the subsequent Step S350.

At Step S350, the CPU 4 determines if the value of the variable Lv is equal to a maximum value Lvmax or 10 in this example or not. If the value of the variable Lv is different from the maximum value Lvmax and has not reached the maximum value Lvmax, the determination at Step S350 is not satisfied. In this case, the CPU 4 increments the value of the variable Lv by 1 at Step S355 and then, the routine returns to Step S315 and repeats the same procedure.

On the other hand, in the determination at Step S345, if there has been some input operation in the operation part 7, the determination is satisfied, and the routine goes to Step S360.

At Step S360, the CPU 4 determines if the input operation detected at Step S345 is an input operation corresponding to “visual discovery” or not. The visual discovery here means that the user has visually found the book B to be searched by referring to display of the detection position of the RFID tag T at Step S335, for example.

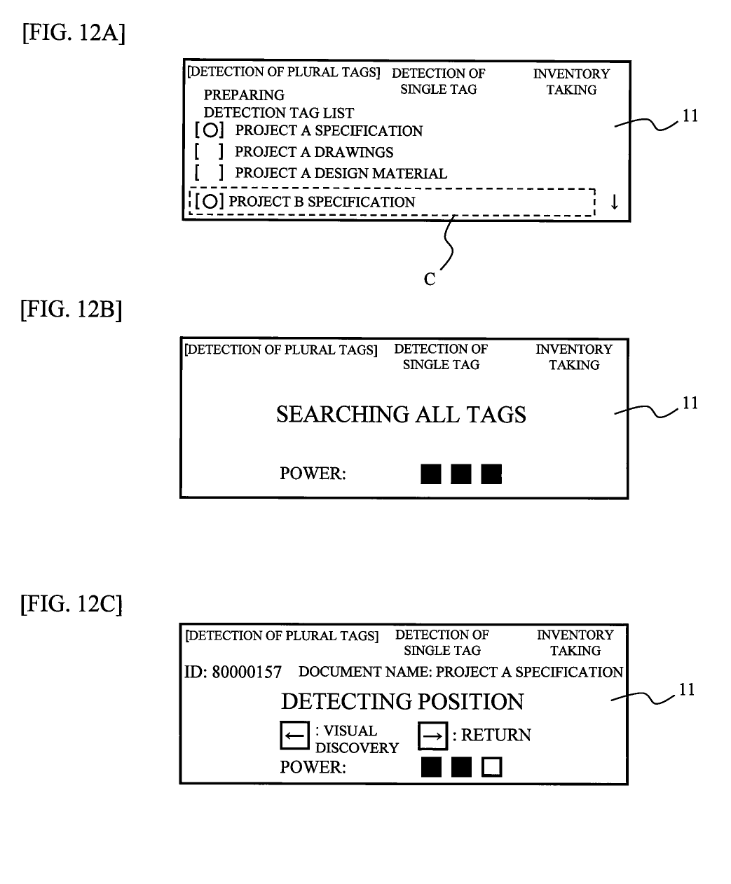

That is, in the single tag detection mode, the reader 1 repeats radio communication even after the arrangement position of the RFID tag T with the tag ID (n) is detected and displayed. However, if the book B to be searched is visually found as above, since the object is achieved for this RFID tag T, it is no longer necessary to search the arrangement position of the RFID tag T with the tag ID(n) by the reader 1. Therefore, if the user wants to stop execution of the single tag detection mode for detecting the RFID tag T with the tag ID(n), the user can make an input operation as indication of intention (See FIG. 12C, which will be described later). If the user's input operation corresponding to the “visual discovery” is made, the determination at Step S360 is satisfied, and the routine goes to Step S365.

At Step S365, the CPU 4 deletes information relating to the tag ID(n) from the detection tag list or the tag ID(n) and the material name in this example, and this flow is finished. As a result, the CPU 4 finishes the single tag detection mode, and the routine goes to Step S50 in FIG. 8. On the other hand, if there has been no input operation corresponding to the “visual discovery”, the determination at Step S360 is not satisfied, and the routine goes to the subsequent Step S370.

At Step S370, the CPU 4 determines if the input operation detected at Step S345 is an input operation corresponding to “RETURN” to finish the single tag detection mode, in other words, if the input operation is an operation to return to the plural tag detection mode in FIG. 9 or the response determination mode in FIG. 10 or not. That is, even if the reader 1 repeats the detection operation for a long time without radio communication with the RFID tag T with the tag ID(n), the user can make the input operation of “RETURN” as indication of intension. The user in this case gives up detection of the RFID tag T and performs the operation to arbitrarily return to the plural tag detection mode or the response determination mode.

If the input operation corresponding to “RETURN” has been made, the determination at Step S370 is satisfied, and this flow is finished. That is, the routine goes to Step S50 in FIG. 8. In this case, the CPU 4 returns to Step S50 in FIG. 8 with the tag ID of the corresponding RFID tag T remaining in the detection tag list. As a result, since the RFID tag T or the book B as a target has not been found yet, the CPU 4 can continue the search in the plural tag detection mode or the response determination mode for another RFID tag T. At that time, the tag ID is not deleted from the detection tag list but left in the list. This is because there is a possibility that position detection processing will be performed again for the RFID tag T with the tag ID at another chance. Also, if the user loses the RFID tag T after switching to the single tag detection mode, the search can be made again from the plural tag detection mode or from the response determination mode.

On the other hand, if the input operation corresponding to the “RETURN” has not been made, the determination at Step S370 is not satisfied, and the routine goes to the subsequent Step S375. At Step S375, the CPU 4 ignores the input operation detected at Step S345, and the routine goes to Step S350.

Also, on the other hand, in the determination at Step S350, if the value of the variable Lv is equal to the maximum value Lvmax or 10 in this example, the determination is satisfied, and the routine goes to Step S380.

At Step S380, the CPU 4 increments the value of the variable F by 1. That is, it means that the reader 1 could not detect the RFID tag T with the tag ID(n) even after the reader 1 has changed the power corresponding to the variable Lv sequentially in all the stages once and conducted communication with the maximum output at Lv=10. Corresponding to that, at Step S380, the CPU 4 increments the number of failure times F at the maximum power by 1.

At the subsequent Step S385, the CPU 4 determines if the value of the variable F corresponding to the number of failure times is equal to the value of a maximum value Fmax or not. If the value of the variable F is different from the maximum value Fmax and has not reached the maximum value Fmax, the determination at Step S385 is not satisfied. In this case, the CPU 4 returns to Step S315 and repeats the same procedure.

On the other hand, if the value of the variable F is equal to the maximum value Fmax, that is, if the value of the variable F has reached the maximum, the determination at Step S385 is satisfied. In this case, at the subsequent Step S390, the CPU 4 displays the fact that detection of the RFID tag T with the tag ID(n) has failed on the display part 8 and then, this flow is finished. That is, in this example, if the reading has failed for the predetermined number of times since communication for position detection was started in the single tag detection mode, the CPU 4 automatically switches the mode to the plural tag detection mode or the response determination mode by a determination procedure at Step S385. That is, the CPU 4 moves to Step S50 in FIG. 8. For the RFID tag T or book B for which the communication for position detection has failed more than the predetermined number times, it might be a case in which the corresponding RFID tag T or book B has moved and left the communication range, for example. Therefore, the CPU 4 considers that a disadvantage due to loss of time is larger even if the position detection is continued. In this case, the reader 1 continues the search for another RFID tag T in the plural tag detection mode or response determination mode. At that time, since the RFID tag T to be detected has not been found yet, the CPU 4 does not delete but leave the tag ID in the list. This is because there is a possibility that position detection processing will be performed again at another chance for the RFID tag circuit element To with the tag ID.

By performing the procedures in the flow as above, only one RFID tag T with the tag ID(n) is searched, and its separation distance from the reader 1 is displayed on the display part 8. When the “visual discovery” or “RETURN” input operation is made by the user, this flow is finished. If the book B to which the RFID tag T with the tag ID(n) is attached has been taken out or a predetermined time has elapsed since radio communication consecutively fails for a long time due to deterioration of the wave environment, for example, this flow is also finished.

When the operator starts a search, if the operator does not press the transmission key 16 while the plural tag detection function is selected as above but presses the transmission key 16 while the single tag detection function is selected, only the flow in FIG. 11 is executed. That is, if Step S390 is finished, the entire control is also finished at that point.

Subsequently, display examples of the liquid crystal panel 11 will be described referring to FIGS. 12A, 12B, and 12C. These illustrated display examples show a case in which the plural tag detection function is selected.

In FIG. 12A, on the liquid crystal panel 11, a part of the material names registered in the registration tag list are enumerated. In the illustrated example, the user moves the cursor C by pressing and operating the two direction keys 14U and 14D corresponding to upper and lower directions. The cursor C is shown by a square frame by a broken line in the figure. The user can also display other material names by keeping on moving the cursor C. Then, if the user presses the determination key 15 when the name of the material to be searched is surrounded by the cursor C, the material name and the corresponding tag ID are selected and extracted from the registration tag list and stored and held in the detection tag list. The detection tag list is created by the operation performed as above by the user.

FIG. 12B illustrates a display example of the liquid crystal panel 11 if the three RFID tags T are specified as targets in the detection tag list created as above. This display example is a display example at the time when the procedure at Step S105 to Step S140 in the plural tag detection mode in FIG. 9 or the procedure at Step S210 to Step S260 in the response determination mode in FIG. 10 is executed. This display example shows a state substantially corresponding to the power at the maximum, and three painted square frames are displayed.

In the display example shown in FIG. 12C, an example is shown that a position of the RFID tag T with the tag ID of “80000157” attached to the book B of “project A specification” is being detected. In the illustrated example, the power is “2” indicating an approximate medium intensity, and two painted square frames are displayed.

Also, in this example, the direction key 14L as a first operating device corresponding to the left direction corresponds to the “visual discovery”. If the user presses down the left direction key 14L in the illustrated display state, information corresponding to the “project A specification” is deleted (See Step S365 in FIG. 11) from the detection tag list. After that, the processing goes to Step S50 in FIG. 8.

Also, in this example, the direction key 14R as a second operating device corresponding to the right direction corresponds to the “RETURN”. If the user presses down the right direction key 14R in the illustrated display state, the processing goes to Step S50 in FIG. 8.

In the above, the procedures at Step S20 to Step S40 in the flow in FIG. 8 constitute a tag number estimation portion.

Also, the procedures at Step S310, Step S315, Step S341, Step S342, and Step S355 in the flow of FIG. 11 constitute an output control portion. Also, the procedure at Step S350 constitutes a first determination portion.

Also, the procedures at Step S15 and Step S45 in the flow of FIG. 8, the procedures at Step S105 and Step S125 in the flow of FIG. 9, the procedure at Step S235 in the flow of FIG. 10, and the procedures at Step S360, Step S370, and Step S385 in the flow of FIG. 11 constitute a mode switching portion.

Also, the procedure at Step S25 in the flow of FIG. 8 constitutes a transmission control portion for estimation, the “Query” command transmitted at Step S25 constitutes a all-tag reading command, and the procedure at Step S30 constitutes a reception control portion for estimation.

Also, the procedure at Step S215 in the flow of FIG. 10 constitutes a tag transmission control portion, the “Query” command transmitted at Step S215 constitutes the all-tag reading command, and the procedures at Step S220 and Step S230 constitute a tag reception control portion.

Also, the procedure at Step S365 in the flow of FIG. 11 functions as a deletion processing portion.

As described above, in the reader 1 of this embodiment, first, by means of the procedures at Step S20 to Step S40 in the flow of FIG. 8, the CPU 4 estimates the tag estimation number X in the communicable area 20 of the reader 1 as a peripheral area. At this time, at Step S40 in the flow of FIG. 8, on the basis of the number of identification slots in which a collision of response signals occurs as a reception status, the CPU 4 estimates the tag estimation number X in the communicable area 20. As a result, if the number of identification slots in which the collision state occurs is large, it can be estimated that the tag estimation number X in the communicable area 20 is relatively large.

Then, at Step S45 in the flow of FIG. 8, the CPU 4 executes mode switching according to the tag estimation number X. That is, if the tag estimation number X in the estimated communicable area 20 is relatively small, the CPU 4 performs sequential check with the detection tag list and examines if the tag in the detection tag list has been received while obtaining information of all the RFID tags T in the vicinity in the response determination mode. As a result, the RFID tags T can be searched more rapidly and efficiently than sequential specification of the tag ID as in the plural tag detection mode. On the other hand, if the tag estimation number X in the estimated communicable area 20 is relatively large, even if the response determination mode is executed, the number of responding tags is too large, and obtainment of information itself becomes difficult or communication time is extended. Thus, in this case, the CPU 4 sequentially specifies the tag IDs in the plural tag detection mode so as to obtain information individually, and the CPU 4 can reliably search each RFID tag T.

As described above, by selecting and switching to the optimal mode according to the estimated tag estimation number X, the reader 1 can search the RFID tags T efficiently and reliably.

When the CPU 4 estimates and calculates the tag estimation number X in the communicable area 20, the estimation calculation can be performed not only based on the number of identification slots in the collision state as above but also based on the number of identification slots in the no-response state or normal response state. That is, if the number of identification slots in the normal response state in which a collision between the response signals does not occur but information can be obtained from the response signal is larger, the CPU 4 can estimate that the tag estimation number X in the communicable area 20 is relatively small and can estimate and calculate the tag estimation number X according to the degree. Also, if the number of identification slots in the empty no-response state in which there is no response signal is larger, the CPU 4 can estimate that the tag estimation number X in the communicable area 20 is relatively small and can estimate and calculate the tag estimation number X according to the degree. Alternatively, estimation can be also made by combining the methods described above as appropriate.

Also, particularly in this embodiment, in the single tag detection mode, the reader 1 can conduct communication for position detection for the specific RFID tag T and detect the position of the RFID tag T on the basis of the communication result. As a result, with regard to the RFID tag T whose tag ID was obtained and specified in the plural tag detection mode or the RFID tag T whose tag ID was obtained and matches the detection tag list in the response determination mode, the position can be detected in the single tag detection mode.

At this time, in the procedure at Step S335 in the flow of FIG. 11, the CPU 4 makes display alarm according to the position information detected in the single tag detection mode, that is, the estimated distance. As a result, the user can visually recognize a distance from the reader 1 to the RFID tag T reliably.

In the example of this embodiment, a distance is displayed on the liquid crystal panel 11 as a numeral value, but visual display such as display of a length of a bar graph with respect to the prescribed scales can be made other than the above. As a mode of the alarm, other than the display alarm to be visually recognized as described above, sound alarm to be acoustically recognized or vibration alarm to be haptically recognized can be also used. The sound alarm includes an alarm using a difference in a pitch of sound, a difference in a width of pulse sound or a difference in tone, for example. Examples of the vibration alarm include an alarm using a difference in amplitude of the vibration or frequency, for example.

Also, particularly in this embodiment, in the procedure at Step S15 in the flow of FIG. 8, if the number of tag IDs included in the detection tag list is less than a predetermined first threshold value N1, the CPU 4 switches the mode to the plural tag detection mode. That is, if the number of RFID tags T is relatively small, it does not take a long time if the tag ID is sequentially specified and searched in the plural tag detection mode. Thus, if the number of tag IDs included in the detection tag list is less than the first threshold value N1, the CPU 4 sequentially specifies the tag ID in the plural tag detection mode regardless of the tag estimation number X so as to individually obtain information. As a result, the reader 1 can reliably search each RFID tag T.

Also, particularly in this embodiment, as for the reader 1, the power in the plural tag detection mode or response determination mode to make a search to see if there is a responding RFID tag T or not is set equal to or larger than the power in the single tag detection mode for position detection. In the example of this embodiment, the power is set at the maximum output value. As a result, the reader 1 can realize a wider communication range and detect as many responses from the RFID tags T as possible.

Also, particularly in this embodiment, the CPU 4 increases and decreases the power in a stepped manner by the procedure at Step S355 in FIG. 11. As a result, at Step S330, the CPU 4 can detect a position where the communication for position detection is barely possible, that is, the communication with the RFID tag circuit element To would not be possible if the output is smaller than that. As a result, the CPU 4 can estimate a distance from the reader 1 to the RFID tag T (See Step S335 in FIG. 11).

Also, particularly in this embodiment, the CPU 4 sets the power corresponding to a predetermined distance range from the reader 1, that is, the power corresponding to the variable Lvmax as a threshold value. If the communication for position detection continuously fails for the predetermined number of times up to the power corresponding to the threshold value Lvmax, the CPU 4 considers that there is no RFID tag T as a position detection target in the distance range. As a result, the CPU 4 can inform the user of the fact (See Step S390 in FIG. 11). In this embodiment, the CPU 4 considers that the RFID tag T as a position detection target is not present in the distance range in the case of continuous failure for a predetermined number of times, but not limited to that, that is, if time is measured and detection continuously fails for a predetermined time, the CPU 4 may consider that the RFID tag T as a position detection target is not present in the distance range.

In the embodiment, the reader 1 changes the power for transmission of a response request signal such as the “Query” command to the RFID tag T in a stepped manner. By determining presence of a response from the RFID tag T by the reader 1 in each stage during the change, a position of the RFID tag T is detected from the separation distance from the reader 1 corresponding to the power in each stage. However, the present invention is not limited to that. That is, the reader 1 may detect the position of the RFID tag T on the basis of received signal intensity when the response signal transmitted from the RFID tag T is received by the reader 1, for example.

In this case, the “RSSI” signal inputted from the RSSI circuit 226 into the CPU 4 in the receiving portion 213 of the RF communication control part 9 indicates the received signal intensity. The larger the distance from the reader 1 to the RFID tag T becomes, the smaller the received signal intensity from the RFID tag T, that is, a level of the “RSSI” signal becomes. Therefore, by detecting the received signal intensity by the RSSI circuit 226 in the communication for position detection, the CPU 4 can estimate a distance to the RFID tag T.

At this time, if the communication for position detection is conducted at a predetermined power, which is a fixed value, for example, from the reader 1, the CPU 4 sets the received signal intensity usually obtained at a position with a distance relatively close to the reader 1 as a threshold value. Then, when the communication for position detection is conducted at the power of the predetermined value, the CPU 4 determines if the received signal intensity detected by the RSSI circuit 226 is less than the predetermined threshold value or not. This function of the CPU 4 constitutes a second determination portion. If the detected received signal intensity is smaller than the threshold value, the CPU 4 can consider that there is no RFID tag T as a position detection target in the distance range, that is, the tag is relatively far. Then, the PCU 4 can inform the user of the fact.

Also, particularly in this embodiment, if the number of tag IDs included in the detection tag list is one, the CPU 4 switches the mode to the single tag detection mode at Step S105 in the flow of FIG. 9. As a result, if there is only one tag ID in the detection tag list, there is no need to go through two stages of search first and then, position detection. Therefore, by executing the single tag detection mode immediately, more efficient position detection can be realized.

Also, particularly in this embodiment, by operation by the operator of the direction keys 14U, 14D and the determination key 15 for movement of the cursor C and selection determination, a tag ID of the RFID tag in the plurality of tag IDs included in the registration tag list for communication for search can be selected and extracted in the plural tag detection mode.

That is, the intension of the user is not always an intention to search all the RFID tags T whose tag IDs are described in the registration tag list. Therefore, by enabling selection and input of a part of the registration tag list in the detection tag list intended by the user, the reader 1 performs communication for search only for the RFID tags T with the tag IDs inputted in the detection tag list as search targets. As a result, convenience for the user can be further improved.

Also, in this embodiment, the CPU 4 determines presence of the tag only by presence of a response from a target tag to the “Query” command, but not limited to that. That is, the CPU 4 may determine presence of the target tag from the tag ID by transmitting “Ack” command with the contents corresponding to the “RN16” command received from the target tag in response to the “Query” command and by receiving the tag information including the tag ID of the RFID tag circuit element To. If this method is used, though time required for the communication is increased, determination accuracy on presence of the tag and the distance to the tag is improved.

The “Select” command, the “Query” command, the “RN16” command, the “Ack” command, the “QueryRep” command, the “QueryAdjust” command, for example, used in the above shall comply with the specification formulated by EPC global. The EPC global is a non-profit corporation jointly established by International EAN Association, which is an international organization of distribution codes, and Uniformed Code Council (UCC), which is an U.S. distribution code organization. Signals complying with other standards will do as long as they serve the same functions.

Other than those described above, methods of the embodiments and each variation may be combined as appropriate for use. For example, in the all specification tag IDs detection processing shown in FIG. 10, all the target tag IDs received in the single session of the “Query” command processing may be held by the CPU 4 and sequentially applied with processing in the single tag detection mode.

Though not specifically exemplified, the present invention should be put into practice with various changes made in a range not departing from its gist.

What is claimed is:

1. An apparatus for communicating with a radio frequency identification (RFID) tag, comprising;
a radio communication device configured to conduct radio communication with a plurality of RFID tag circuit elements, each of the RFID tag circuit elements having an IC circuit part storing information and a tag antenna capable of transmission and reception of the information;
a tag number estimation portion configured to estimate the number of said RFID tag circuit elements in a peripheral area of said apparatus;
a storage device configured to store a list of identification information of each of a plurality of said RFID tag circuit elements as search targets; and
a mode switching portion configured to switch a mode into a plural tag detection mode or a response determination mode on the basis of a estimation result by said tag number estimation portion, the plural tag detection mode being a mode in which identification information is sequentially specified in said list stored in said storage device before the RFID tag circuit element corresponding to the specified identification information is detected through said radio communication device, the response determination mode being a mode in which identification information is obtained from each of all the RFID tag circuit elements in said peripheral area through said radio communication device before presence of each of the RFID tag circuit elements respectively corresponding to the identification information in said list is determined on the basis of the obtained identification information.

2. The apparatus according to claim 1, wherein:
said mode switching portion switches a mode into said plural tag detection mode in the case that the number of said identification information included in said list stored in said storage device is less than a predetermined first threshold value.

3. The apparatus according to claim 1, wherein:
said mode switching portion switches a mode into said response determination mode in the case that the number of said RFID tag circuit elements in said peripheral area estimated by said tag number estimation portion is less than a predetermined second threshold value and into said plural tag detection mode in the case that the number of said RFID tag circuit elements in said peripheral area estimated by said tag number estimation portion is not less than said second threshold value.

4. The apparatus according to claim 3, wherein:
said tag number estimation portion conducts communication for estimation with said RFID tag circuit elements in said peripheral area through said radio communication device and estimates the number of said RFID tag circuit elements in the peripheral area according to a communication result.

5. The apparatus according to claim 4, wherein:
said tag number estimation portion includes:
a transmission control portion for estimation configured to create a all-tag reading command to obtain identification information stored in said IC circuit parts of all the RFID tag circuit elements in said peripheral area and to transmit the command to said RFID tag circuit element through said radio communication device; and
a reception control portion for estimation capable of receiving a response signal by using one of a plurality of identification slots divided, said response signal transmitted from said RFID tag circuit element in response to said all-tag reading command created and transmitted by said transmission control portion for estimation, and
said tag number estimation portion estimates the number of said RFID tag circuit element in said peripheral area on the basis of a reception state of the response signal by said reception control portion for estimation when the number of said identification slots is limited to a predetermined value or less.

6. The apparatus according to claim 5, wherein:
said tag number estimation portion estimates the number of said RFID tag circuit elements in said peripheral area on the basis of the number of said identification slots in which a collision of said response signal occurs as said reception state.

7. The apparatus according to claim 5, wherein:
said tag number estimation portion estimates the number of said RFID tag circuit elements in said peripheral area on the basis of the number of said identification slots in which the collision of said response signal does not occur and information can be obtained from said response signal as said reception state.

8. The apparatus according to claim 5, wherein:
said tag number estimation portion estimates the number of said RFID tag circuit elements in said peripheral area on the basis of the number of said identification slots, which are empty, in which said response signal is not present as said reception state.

9. The apparatus according to claim 5, further comprising:
a tag transmission control portion configured to create said all-tag reading command to obtain identification information stored in said IC circuit part of all of the RFID tag circuit elements in said peripheral area in said response determination mode and to transmit the command to said RFID tag circuit element through said radio communication device; and
a tag reception control portion capable of receiving a response signal in said response determination mode by using one of a plurality of identification slots divided, said response signal transmitted from said RFID tag circuit element in response to said all-tag reading command created and transmitted by said tag transmission control portion.

10. The apparatus according to claim 9, wherein:
said tag reception control portion receives the response signal by using the identification slot number larger than the identification slot number used by said reception control portion for estimation.

11. The apparatus according to claim 5, wherein:
said mode switching portion is configured to be capable of switching a mode into a single tag detection mode in which communication for position detection for specific said RFID tag circuit element is conducted through said radio communication device and a position of the specific said RFID tag circuit element is detected on the basis of the communication result.

12. The apparatus according to claim 11, wherein:
said mode switching portion switches a mode into said single tag detection mode when information is obtained from said RFID tag circuit element in said plural tag detection mode, and specifies said RFID tag circuit element from which the information was obtained, so as to detect a position of the RFID tag circuit element.

13. The apparatus according to claim 11, wherein:
said mode switching portion switches a mode into said single tag detection mode when identification information in said list is obtained from the information obtained in said response determination mode, and specifies said RFID tag circuit element corresponding to the obtained identification information, so as to detect a position of the RFID tag circuit element.

14. The apparatus according to claim 11, further comprising
an output control portion configured to set intensity of a power of said radio communication device when said position detection is performed in said single tag detection mode at intensity or less of the power of said radio communication device when information is obtained in said plural tag detection mode or said response determination mode.

15. The apparatus according to claim 14, wherein:
said output control portion can control to increase and decrease intensity of said power in a stepped manner; and
in said single tag detection mode, a position detection of said RFID tag circuit element is performed on the basis of a communication result of said communication for position detection when the intensity of said power is increased and decreased by said output control portion in the stepped manner.

16. The apparatus according to claim 11, wherein:
said radio communication device has an intensity detecting device configured to detect received signal intensity from said RFID tag circuit element; and
in said single tag detection mode, a position detection of said RFID tag circuit element is performed on the basis of a detection result of said intensity detecting device in said communication for position detection.

17. The apparatus according to claim 15, further comprising
an alarm device for making at least one alarm among display alarm, sound alarm, and vibration alarm, on the basis of a position information detected.

18. The apparatus according to claim 17, wherein:
said mode switching portion switches a mode into said single tag detection mode so as to start said communication for position detection and then, in the case that a state in which there is no response from the RFID tag circuit element as a target of the position detection continues for a predetermined time, the mode switching portion switches a mode into said plural tag detection mode or response determination mode while said identification information of the RFID tag circuit element as the target of the position detection is left in said list of said storage device.

19. The apparatus according to claim 11, wherein:
said mode switching portion switches a mode into said single tag detection mode in the case that there is one identification information included in said list stored in said storage device.

20. The apparatus according to claim 11, further comprising a selection operating device capable of selection and input of identification information of at least one RFID tag circuit elements to which communication for search is conducted in said plural tag detection mode or said response determination mode, identification information being selected or inputted from among the identification information included in said list, wherein
in said plural tag detection mode, said information is obtained with said RFID tag circuit element for which said identification information is selected by said selection operating device as a search target; and
in said response determination mode, said identification information selected by said selection operating device from said list is obtained from the obtained information.
